(19) United States
(12) Patent Application Publication
(10) Pub. No.: US 2002/0080046 A1
(43) Pub. Date: Jun. 27, 2002

(54) Apparatus and method for detecting objects located on an airport runway

(76) Inventor: Byron Scott Derringer, Arlington, VA (US)

Correspondence Address: COLLIER, SHANNON, SCOTT, PLLC, 3050 K STREET, NW, SUITE 400, WASHINGTON, DC, 20007, US

(21) Appl. No.: 09/988,376

(22) Filed: Nov. 19, 2001

Related U.S. Application Data
(63) Continuation-in-part of application No. 09/742,540, filed on Dec. 22, 2000, now abandoned.

(51) Int. Cl. G08B 21/00

(52) U.S. Cl. 340/945; 340/961

(57) ABSTRACT

An apparatus and method for detecting objects or other debris located on an airport runway including an optical laser system for sensing the presence of objects or other debris, object location and object characterizer processing apparatus for receiving an output from the optical laser system for locating and characterizing objects or other debris sensed by the optical laser system, an alarm activation processing apparatus for receiving input from the object location and characterizer processing apparatus or other debris sensing apparatus for indicating the alarm status of objects or other debris and providing an output indication to alarm generating apparatus and to a user interface to alert appropriate personnel.

### CROSS REFERENCE TO RELATED PATENT APPLICATION

This application is a continuation-in-part of, and claims priority on, U.S. patent application Ser. No. 09/742,540 for METHOD AND APPARATUS FOR WARNING AND DETECTING DEBRIS LOCATED ON AIRPORT RUNWAY SURFACE, filed on Dec. 22, 2000.

### FIELD OF THE INVENTION

The present invention relates to an apparatus and method for detecting objects located on an airport runway. More particularly, the present invention is an apparatus and method employing optical transmitters, transceivers, receivers, reflectors, and various processing means for detecting objects located on an airport runway.

### BACKGROUND OF THE INVENTION

The problems associated with objects located on airport runway surfaces during aircraft landing and take off have long been recognized. There have been repeated catastrophes associated with objects or other debris on airport runway surfaces involving deaths of thousands of people and damage to aircraft. Aircraft are operated by pilots often unfamiliar with individual airports and runways, and possibly without adequate visibility during take off or landing. Even the presence of air traffic control does not wholly eliminate the hazard of unseen objects on the runway to the aircraft and its passengers.

There are many recent articles relating to aircraft catastrophes in relation to the presence of objects or other debris on airport runway surfaces. Examples of such articles include the following references, the disclosure of which are hereby incorporated by reference:

Alan Cowell, Concorde is Stripped of Certification to Fly, N.Y. Times, Aug. 17, 2000, Foreign Desk; Suzanne Daley, Recorders Show 2 Engines in Trouble Before Paris Crash, N.Y. Times, Jul. 28, 2000, Foreign Desk; Erik Eckholm, Airline Says Jet Was on Wrong Runway Before Crash in Taiwan, N.Y. Times, Nov. 4, 2000, Foreign Desk; Erik Eckholm, Taiwan Crash Recorders Checked; No Theories Ruled Out, N.Y. Times, Nov. 2, 2000, Foreign Desk; Donald G. McNeil Jr., A Key Runway Inspection Was Skipped the Day of the Concorde Crash, Investigators Report, N.Y. Times, Sep. 2, 2000; and Pilots' ‘Dreadful Mistake’ in Taiwan May Lead to Jail, N.Y. Times, Nov. 5, 2000, Foreign Desk.

Applicant is unaware of any information regarding past prior art similar to the present invention for a sensing system for detecting objects or other debris that may be hazardous to aircraft and/or passengers on an airport runway surface.

Consequently, due to recent aviation catastrophes or near disasters that are attributable to objects or other debris on the airport runway surface when the aircraft are either taking off or landing, there is a need to develop and apparatus and system to locate, characterize, and alert appropriate airport personnel to the presence of objects or other debris on airport runways.

It is known that the Supersonic Air France Concorde crash on Jul. 26, 2000 was attributed to objects or other debris left on the airport runway prior to the Concorde's departure from Charles de Gaulle Airport in France. French investigators indicated that “a 16-inch piece of metal on the runway had burst the tire, setting off the sequence of apparently freakish events that caused the plane to crash within 90 seconds” after takeoff. Alan Cowell, Concorde Is Stripped of Certification to Fly, N.Y. Times, Aug. 17, 2000, Foreign Desk. In fact, it has been said that “objects or other debris on the runway [is] most often the problem” in catastrophes when aircraft are landing and taking off. Suzanne Daley, Recorders Show 2 Engines in Trouble Before Paris Crash, N.Y. Times, Jul. 28, 2000, Foreign Desk. Most importantly, the present invention may alleviate the problem of “inspections [being] skipped” and ensure that airport runway surfaces would be clear of any objects or other debris. Donald G. McNeil Jr., A Key Runway Inspection Was Skipped the Day of the Concorde Crash, Investigators Report, N.Y. Times, Sep. 2, 2000.

In a more recent catastrophe involving an airline in Taiwan, killing 80 people, the pilot was unaware of his surroundings and claimed that “from beginning to end, didn't know he was using the wrong runway” during take off. Apparently, this is a common mistake due to location of the pilot in the aircraft, the familiarity of the pilot with the airport, or other visibility issues. The present invention would allow air traffic control or other personnel to assess the location of any aircraft on any runway as well as the condition of the runway surface prior to clearing the aircraft for takeoff. Understanding that the air traffic control tower in this incident did not have the best view, the present invention would provide another method to double check the runway prior to clearing an aircraft for takeoff. Erik Eckholm, Airline Says Jet Was on Wrong Runway Before Crash in Taiwan, N.Y. Times, Nov. 4, 2000, Foreign Desk. Considering all factors in the tragic airline crash in Taiwan, the present invention would help prevent an aircraft from traveling down “a runway that was closed for repairs and littered with heavy digging equipment”. Pilots' ‘Dreadful Mistake’ in Taiwan May Lead to Jail, N.Y. Times, Nov. 5, 2000, Foreign Desk.

However, despite this prior public knowledge, Applicant is unaware of any known, proposed, or successfully implemented sensing systems for detecting objects or other debris on an airport runway surface which would provide an advance warning to air traffic control and airport ground based personnel.

Consequently, there exists a need to detect such objects or other debris on runway surfaces.

Furthermore, there exists a need to notify air traffic control and ground based personnel of such objects or other debris prior to aircraft takeoff or landing.

### OBJECTS OF THE INVENTION

An object of the present invention is to provide a novel apparatus and method for detecting objects or other debris on airport runway surfaces that may pose a hazard to aircraft and passengers.

An object of the present invention is to provide a novel apparatus and method that can detect objects or other debris on an airport runway surface and provide an early warning signal to the aircraft, air traffic control, and/or ground based personnel.

An object of the present invention is to provide a novel apparatus and method that can provide information to the aircraft, air traffic control, and/or ground based personnel prior to aircraft landing and takeoff, thus providing time for corrective action to clear the airport runway surface prior to landing and takeoff. Air traffic control and ground based personnel may be provided with prior knowledge of objects or other debris prior to aircraft touch down on the airport runway surface.

An object of the present invention is to provide a novel apparatus and method that may direct one or more laser beams across an airport runway surface that may contain objects or other debris. As a result the novel apparatus, the invention can provide a sufficient period of time for the aircraft, air traffic control, and/or ground based personnel to take corrective action to avoid the hazardous conditions.

Optical laser systems that would be used in conjunction with the present invention would depend on the different weather conditions that may be present, such as, but not limited to, fog, rain, ice, snow, wind, dust, or any other type of inclement weather or adverse conditions.

An object of the present invention is to provide a novel apparatus and method that can provide information directly to air traffic control and/or ground based personnel from one, or several laser beams located on the perimeter of the airport runway surface in order to provide the necessary information to direct the approach, landing, or takeoff of an aircraft.

### SUMMARY OF THE INVENTION

Responsive to the foregoing challenges, Applicant has developed an innovative apparatus and method for detecting objects on an airport runway comprising: an optical system; an object location processor operably linked to the optical system; an object characterizer operably linked to the object location processor; an alarm activation processor operably linked to the object characterizer; an alarm generator operably linked to the alarm activation processor; and a user interface operably linked to the alarm generator.

The optical system may further comprise one or more optical transmitters and one or more optical receivers, and/or one or more optical transceivers and one or more optical reflectors, or any combination of transmitters, receivers, transceivers, and reflectors. The object location processor may further comprise an intrusion sensor detection system, an operation sensor detection system, and/or an output inspector diagnostic system.

The object characterizer may further comprise a motion detection processor. The user interface may further comprise a graphical interface, a no alarm indicator, a future risk indicator, and/or an imminent danger indicator.

The apparatus may comprise a support mechanism for the optical system, and the support mechanism may further comprise means for adjusting the height of the support mechanism and/or the height of the optical system. The support mechanism may further comprise means for heating the support mechanism and/or the optical system. The apparatus may comprise a protective cover for the optical system.

An alternative preferred embodiment of the present invention is an apparatus and method for detecting objects or other debris located on an airport runway surface comprising: one or more optical laser transmitters and one or more optical laser receivers for sensing the presence of objects on an airport runway surface, and/or comprising a plurality of optical laser transmitters arranged to transmit optical laser beams across portions of the runway surface; a plurality of optical laser receivers arranged to receive the optical lasers, and processing means to process signals from the plurality of optical laser receivers to determine the presence of an object on the runway.

The apparatus may further comprise reflectors arranged to reflect the optical lasers to the optical laser receivers, and one or more optical laser transceivers and one or more optical laser reflectors for sensing the presence of objects on an airport runway surface.

There is thus provided in accordance with a preferred embodiment of the present invention an apparatus and method for warning and detecting objects or other debris located on airport runway surface, comprising: optical laser transmission and receiving apparatus for sensing the presence of objects or other debris within a spatial range relative to an aircraft; optical laser transceiver and reflector apparatus for sensing the presence of objects or other debris within a spatial range relative to an aircraft; multiple objects or other debris processing apparatus receiving an output from the optical laser transmission and receiving apparatus for tracking a plurality of objects or other debris sensed by the optical laser transmission and receiving apparatus; multiple objects or other debris processing apparatus receiving an output from the optical laser transceiver and reflector apparatus for tracking a plurality of objects or other debris sensed by the optical laser transceiver and reflector apparatus; auxiliary non-optical laser objects or other debris sensing apparatus; and alarm processing apparatus receiving an input from the non-optical system components, including, but not limited to, the object location processor, the object characterizer, and the alarm activation processor, or other debris sensing apparatus for indicating the alarm status of an object and providing an output indication to alarm generating apparatus.

In accordance with a preferred embodiment of the present invention, the non-optical system or other debris sensing apparatus processing means may be in communication with an optical laser transmitter and optical laser receiver. Also, in accordance with a preferred embodiment of the present invention, the non-optical laser system or other debris sensing apparatus processing means may be in communication with a laser energy transceiver and reflector.

Additionally in accordance with an embodiment of the present invention, the system can also include alarm generating apparatus for providing an indication of alarm status to air traffic control and ground based personnel. Preferably, the optical laser transmission and receiving apparatus includes plural optical laser apparatus.

In accordance with a preferred embodiment of the present invention, the plural optical laser apparatus includes at least one optical laser for sensing location. Preferably, the plural optical laser apparatus includes a plurality of optical laser apparatus for objects or other debris detection.

In accordance with a preferred embodiment of the present invention, the plurality of optical laser apparatus are arranged such that their detection regions are distributed in partially overlapping orientation in azimuth fashion, thereby covering the airport runway surface. Preferably, the optical laser transmission and receiving apparatus also includes apparatus for comparing the outputs of more than one of the plurality of optical laser relating to a given object in order to define the angular position of the object with enhanced resolution.

In accordance with a preferred embodiment of the present invention, at least one of the optical laser transmission and receiving apparatus and the multiple objects or other debris optical laser apparatus includes a motion processorapparatus for distinguishing moving objects or other debris from stationary objects or other debris.

Additionally, in accordance with a preferred embodiment of the present invention, at least one of the optical laser transceiver and reflector apparatus and the object characterizer apparatus include apparatus for distinguishing moving objects or other debris from stationary objects or other debris. Preferably, the object characterizer apparatus provides an output indication of the velocity vector of a plurality of moving objects or other debris.

Additionally, in accordance with a preferred embodiment of the present invention, the object characterizer apparatus includes apparatus for disregarding objects or objects or other debris whose vectors do not fit within a predetermined profile.

Further in accordance with a preferred embodiment of the present invention, the object characterizer apparatus includes apparatus for disregarding objects or other debris whose vectors do not fall within a danger envelope defined with respect to the landing and take off vector of an aircraft. Characteristics of the aircraft such as a proximity to objects or other debris are also termed herein “own” characteristics, such as “own proximity to objects or other debris”.

In accordance with a preferred embodiment of the present invention, the auxiliary non-optical laser system or other debris sensing apparatus includes optical laser apparatus for defining first and second generally vertical beam walls which delimit a range of protection with respect to a protected aircraft.

Additionally, in accordance with a preferred embodiment of the present invention, the auxiliary non-optical laser system or other debris sensing apparatus includes optical laser apparatus for defining a generally horizontal beam fan spaced from the airport runway surface which at least partially delimits a range of protection with respect to a protected aircraft.

Further in accordance with a preferred embodiment of the present present invention, the system also includes operation sensors and output inspector apparatus for sensing impaired operation of the optical laser system or other debris sensing apparatus and for modifying the operation of the system in accordance therewith. In accordance with a preferred embodiment of the present invention, the apparatus for sensing and modifying includes apparatus for operating the optical laser transmitting and receiving apparatus in an occupancy probability sensing mode of operation.

There is also provided in accordance with a preferred embodiment of the present invention a method for warning and detecting objects or other debris located on airport runway surface including the steps of: optical laser sensing the presence of objects or other debris within a spatial range relative to the airport runway surface; multiple objects or other debris tracking a plurality of objects or other debris sensed by optical laser; sensing objects or other debris by auxiliary non-optical sensing techniques; and receiving a multiple objects or other debris tracking input and an auxiliary non-optical objects or other debris sensing input and on the basis thereof indicating the alarm status of a target and providing an output indication to air traffic control and ground based personnel.

In accordance with a preferred embodiment of the present invention, the auxiliary non-optical laser system or other debris sensing step may include a laser energy transmission and reception step. Preferably, the optical laser sensing step includes comparing the outputs of more than one of a plurality of optical-lasers relating to a given object in order to define the angular position of the object with enhanced resolution.

In accordance with a preferred embodiment of the present invention, at least one of the optical laser sensing and the multiple objects or other debris tracking steps includes distinguishing moving objects or other debris from stationary objects or other debris. Preferably, the multiple objects or other debris tracking step provides an output indication of the vector of the plurality of moving objects or other debris.

Additionally in accordance with a preferred embodiment of the present invention, the multiple objects or other debris tracking step is operative for disregarding objects or other debris whose vectors do not fit within a predetermined profile.

Further in accordance with a preferred embodiment of the present invention, the step of disregarding includes disregarding objects or other debris whose vectors do not fall within a danger envelope defined with respect to the vector of the protected aircraft.

In accordance with a preferred embodiment of the present invention, the auxiliary non-optical objects or other debris sensing step includes defining first and second generally vertical optical-laser beam walls which delimit a range of protection with respect to a protected aircraft.

Additionally in accordance with a preferred embodiment of the present invention, the auxiliary non-optical laser system or other debris sensing step includes defining a generally horizontal optical laser beam fan spaced from the airport runway surface which at least partially delimits a range of protection with respect to a protected aircraft.

Further in accordance with a preferred embodiment of the present invention, the method also includes the steps of sensing impaired auxiliary non-optical system or other debris sensing and modifying operation in accordance therewith (i.e. rain, snow, ice, fog, wind, dust, or any other type of inclement weather or adverse condition).

In accordance with a preferred embodiment of the present invention, the steps of sensing and modifying include operating the optical laser transmitting and receiving apparatus in an occupancy probability sensing mode of operation.

Additionally in accordance with a preferred embodiment of the present invention, the steps of sensing and modifying include operating the optical laser transceiver and reflector apparatus in an occupancy probability sensing mode of operation.

There are three additional advantages of the embodiments of the present invention: 1. the use of the optical laser apparatus and method allows detection of objects and other objects or other debris in weather where visibility is very low (i.e. fog or any other type of inclement weather or adverse condition), 2. the use of the method with transceiver to reflector will be more cost effective in construction based on the expense of reflectors versus receivers, and 3. prevention/warning of incursion of other aircraft within the same space.

Other objects and advantages will become apparent from reading the following detailed description of the invention wherein reference is made to the accompanying drawings.

Moreover, the above objects and advantages of the present invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

Embodiments of the present invention are explained in greater detail by way of the drawings, where the same reference numerals refer to the same features.

FIG. 1 is a flow diagram illustrating the apparatus and method according to a preferred embodiment of the present invention.

FIG. 2 illustrates a 3-dimentional frontal view of the airport runway surface with optical laser embodiments present.

FIG. 3 is 3-dimentionally presented as a side view of the airport runway surface with optical laser embodiments present around the parameter.

FIG. 4 is a top view of the airport runway surface with optical laser embodiments present on both sides showing laser beam configuration covering width of area specified in both directions constantly traveling through several different planes.

FIG. 4A is a simplified description of the path for the optical laser.

FIG. 5 is a top view of the airport runway surface with optical laser embodiments present on both sides showing laser beam configuration covering width of area specified in one direction constantly traveling through several different planes.

FIG. 5A is a simplified description of the path for the optical laser.

FIG. 6 is a top view of the airport runway surface with optical laser embodiments present on both sides and on each end showing laser beam configuration covering the length and width of area specified in three different directions constantly traveling through several different planes.

FIG. 6A is a simplified top view of the airport runway surface illustrating where optical laser would provide protection for aircraft in landing and take off sections of the airport runway surface.

FIG. 7 illustrates a top view of the entire airport runway surface with optical laser embodiments present on both sides showing laser beam configuration covering the width of area specified in both directions constantly traveling through several different planes.

FIG. 7A is a simplified top view of the airport runway surface illustrating where optical laser would provide protection for aircraft in landing and take off sections of the airport runway surface.

FIG. 8 is a front view of a convex airport runway surface with optical laser embodiments present on both sides showing laser beam configuration covering the width of the area specified in one direction from left to right constantly traveling through several different planes.

FIG. 9 is a front view of a convex airport runway surface with optical laser embodiments present on both sides showing laser beam configuration covering the width of the area specified in both directions constantly traveling through several different planes.

FIG. 10 is a top view of the entire airport runway surface with optical laser embodiments present on all sides showing the laser beam configuration covering both width and length of the area specified. Laser beam are in four different constant directions, two of which are sweeping both left and right traveling through several different planes.

FIG. 11 is a top view of the airport runway surface with optical laser embodiments present on all sides showing the laser beam configuration covering in a constant direction both width and length of the area specified. Laser beam are in three different constant directions, two of which are sweeping both left and right traveling through several different planes.

FIG. 12 is a top view of the airport runway surface with optical laser embodiments present at both ends of landing and take off portions of airport runway surface showing laser beam configuration covering in a constant direction both width and length of the area specified. Laser beam are in four different constant directions, two of which are sweeping both left and right traveling through several different planes.

FIG. 12A is a simplified top view of the airport runway surface illustrating where optical laser would provide protection for aircraft in landing and take off sections of the airport runway surface.

FIG. 13 is a top view of the airport runway surface with optical laser embodiments present along parameter showing laser beam configuration covering length and width of the area specified in four different constant directions, two of which are sweeping both left and right traveling through several different planes.

FIG. 13A is a simplified top view of the airport runway surface illustrating where optical laser would provide protection for aircraft in landing and take off sections of the airport runway surface.

FIG. 14 is a top view of the airport runway surface with optical laser embodiments present on one side showing laser beam configuration covering the width of area specified in two constant directions traveling through several different planes.

FIG. 14A is a simplified top view of the airport runway surface illustrating where optical laser would provide protection for aircraft in landing and take off sections of the airport runway surface.

FIG. 15 is a top view of the airport runway surface with optical laser embodiments present on both sides showing laser beam configuration covering the width of the area specified in three constant directions traveling through several different planes.

FIG. 15A is a simplified top view of the airport runway surface illustrating where optical laser would provide protection for aircraft in landing and take off sections of the airport runway surface.

FIG. 16 is a top view of the airport runway surface with optical laser embodiments present on all four sides showing laser beam configuration covering both length and width of the area specified in two constant directions traveling through several different planes.

FIG. 16A is a simplified top view of the airport runway surface illustrating where optical laser would provide protection for aircraft in landing and take off sections of the airport runway surface.

FIG. 17 is a top view of the airport runway surface with optical laser embodiments present on all four sides showing laser beam configuration covering both length and width of the area in one constant direction traveling through several different planes.

FIG. 17A is a simplified top view of the airport runway surface illustrating where optical laser would provide protection for aircraft in landing and take off sections of the airport runway surface.

FIG. 18 is a top view of the airport runway surface with optical laser embodiments present at both ends of the airport runway surface showing laser beam configuration covering the length and width of specified areas in one direction constantly traveling through several different planes.

FIG. 18A is a simplified top view of the airport runway surface illustrating where optical laser would provide protection for aircraft in landing and take off sections of the airport runway surface.

FIG. 19 is a top view of the airport runway surface with optical laser embodiments present at both ends of the airport runway surface showing laser beam configuration covering the length and width of specified area from three different directions constantly traveling through several different planes.

FIG. 19A is a simplified top view of the airport runway surface illustrating where optical laser would provide protection for aircraft in landing and take off sections of the airport runway surface.

FIG. 20 is a top view of the airport runway surface with optical laser embodiments present at all four corners of the airport runway surface showing laser beam configuration covering the length and width of specified area from four different directions constantly traveling through several different planes.

FIG. 20A is a simplified top view of the airport runway surface illustrating where optical laser would provide protection for aircraft in landing and take off sections of the airport runway surface.

FIG. 21 is a front view of a convex airport runway surface with optical laser embodiments present on both sides showing laser beam configuration covering the width of the area specified in both directions constantly traveling through one plane.

FIG. 22 is a front view of a convex airport runway surface with optical laser embodiments present on both sides showing laser beam configuration covering the width of the area specified in one direction constantly traveling through several different planes from left to right.

FIG. 23 is a front view of a convex airport runway surface with optical laser embodiments present on both sides showing laser beam configuration covering the width of the area specified in one direction constantly traveling through several different planes from right to left.

FIG. 24 is a front view of a convex airport runway surface with optical laser embodiments present on both sides showing laser beam configuration covering the width of the area specified in both directions constantly traveling through several different planes.

FIG. 25 is a front view of a convex airport runway surface, specifically showing a sectional view of the support for holding the optical laser embodiment located at the width of the airport runway surface. Illustrating that the inner core would maintain a constant temperature during inclement weather to prevent the freezing of all embodiments.

FIG. 26 is a front view of a convex airport runway surface, specifically showing the movement of raising and lowering the entire support for holding the optical laser embodiment located at the width of the airport runway surface. Illustrating the above and below ground location of embodiments in order to prevent obstacles during the removal of snow and ice from the airport runway surface.

FIG. 27 is a detailed description of the clear covering that provides protection during inclement weather for the optical laser embodiment in order to ensure consistent results not having weather be a factor for reliability.

FIG. 28 is a top view of the airport runway surface with optical laser embodiment present on both sides of the width showing a constant laser beam configuration covering the width of the area specified in one direction constantly traveling through several different planes.

FIG. 28A is a simplified top view of the airport runway surface illustrating where optical laser would provide protection for aircraft in landing and take off sections of the airport runway surface.

FIG. 29 is a top view of the airport runway surface with optical laser embodiment present on both sides of the width showing a laser beam configuration covering width of area specified in two directions constantly traveling through several different planes.

FIG. 29A is a simplified top view of the airport runway surface illustrating where optical laser would provide protection for aircraft in landing and take off sections of the airport runway surface.

FIG. 30 is a top view of the airport runway surface with optical laser embodiment present on both sides of the width showing a laser beam configuration covering length and width of area specified in one direction constantly traveling through several different planes.

FIG. 30A is a simplified top view of the airport runway surface illustrating where optical laser would provide protection for aircraft in landing and take off sections of the airport runway surface.

FIG. 31 is a top view of the airport runway surface with optical laser embodiment present on both sides of the width showing a laser beam configuration covering length and width of area specified in two directions constantly traveling through several different planes.

FIG. 31A is a simplified top view of the airport runway surface illustrating where optical laser would provide protection for aircraft in landing and take off sections of the airport runway surface.

FIG. 32 is a top view of the airport runway surface with optical laser embodiment present on both sides of the width showing a laser beam configuration covering length, width, and diagonal regions of specified area in two directions constantly traveling through several different planes.

FIG. 32A is a simplified top view of the airport runway surface illustrating where optical laser would provide protection for aircraft in landing and take off sections of the airport runway surface.

### DETAILED DESCRIPTION OF THE INVENTION

Definitions

In describing the present invention, the following definitions are applicable throughout.

“airport runway surface” refers to all areas and any surface in the airport region traveled by aircraft and/or passengers.

“air traffic control” refers to all personnel responsible for air traffic control, whether located in the air traffic control tower or elsewhere.

“objects or other debris” refer to any and all objects (including, but not limited to, ice, snow, pieces of aircraft, animals, ground based equipment, vehicles, etc.) located in the spatial region of the airport runway surface intended for aircraft or passenger travel.

“ground based personnel” refer to all personnel located as support located within the region of the airport.

“optical laser” refers to all optical beams traveling over the airport runway surface, which may detect objects and other debris on the airport runway surface.

Preferred Embodiments

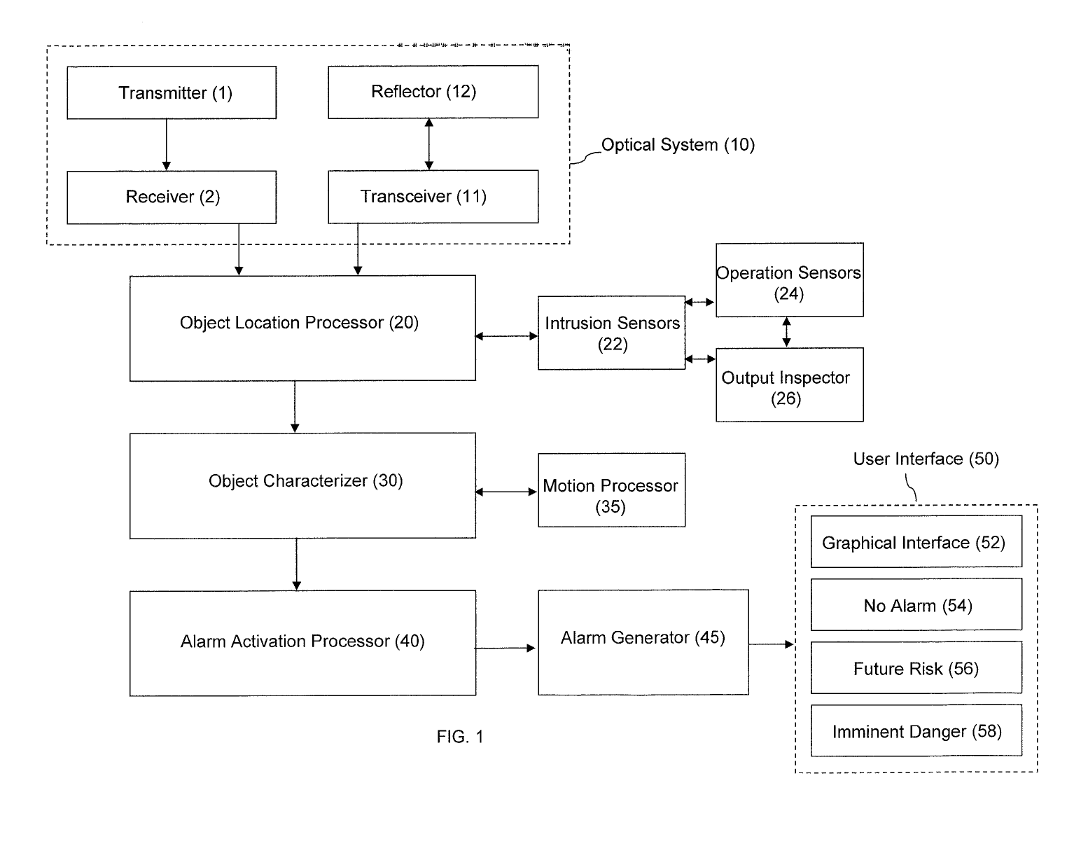

Reference will now be made in detail to a preferred embodiment of the present invention, an example of which is illustrated in the accompanying drawings. With reference to FIG. 1, the apparatus and method for detecting objects or other debris on an airport runway 3 comprises an optical system 10, an object location processor 20 operably linked to the optical system 10, an object characterizer 30 operably linked to the object location processor 20, an alarm activation processor 40 operably linked to the object characterizer 30, an alarm generator 45 operably linked to the alarm activation processor 40, and a user interface 50 operably linked to the alarm generator 45.

In an alternative preferred embodiment the optical system 10 may further comprise one or more optical transmitters 1 and one or more optical receivers 2. The optical system 10 may also comprise one or more optical transceivers 11 and one or more optical reflectors 12. The optical system 10 may also comprise any combination of optical transmitters 1, optical receivers 2, optical transceivers 11, and optical reflectors 12.

In an alternative preferred embodiment the object location processor 20 may further comprise an intrusion sensor detection system 22. The object location processor 20 may further comprise an operation sensor detection system 24. In addition, the object location processor 20 may further comprise an output inspector diagnostic system 26. The object characterizer 30 may further comprise a motion detection processor 35.

In an alternative preferred embodiment, the user interface 50 may further comprise a graphical interface 52 that includes a no alarm indicator 54, a future risk indicator 56, and/or an imminent danger indicator 58, to warn the appropriate personnel of objects on the runway 3.

The apparatus and method may also comprise a support mechanism 6 for the optical system 10. The support mechanism 6 may further comprise means 8 for adjusting the height of the support mechanism 6 and/or the height of the optical system 10. The support mechanism 6 may further comprise heating means 13 for heating the support mechanism 6 and/or the optical system 10 to prevent the apparatus from freezing. The optical system 10 may further comprise a protective cover 14 to protect the optical system 10 from inclement weather.

An alternative preferred embodiment of the present invention is an apparatus and method for detecting objects or other debris located on an airport runway surface 3 comprising one or more optical laser transmitters 1 and one or more optical laser receivers 2 for sensing the presence of objects on an airport runway surface 3.

An alternative preferred embodiment of the present invention is an apparatus and method for detecting objects or other debris on an airport runway surface 3 comprising a plurality of optical laser transmitters 1 arranged to transmit optical laser beams 4 across portions of said runway surface 3 and a plurality of optical laser receivers 2 arranged to receive said optical lasers 4, and processing means 20, 30, 45, 45, 50 to process signals from said plurality of optical laser receivers 2 to determine the presence of an object on the runway surface 3. The apparatus and method may also comprise one or more optical laser transceivers 11 and one or more optical laser reflectors 12 for sensing the presence of objects on an airport runway surface.

In an alternative preferred embodiment of the present invention, optical laser transceivers 11 and optical laser reflectors 12 are arranged to reflect said optical lasers 4 back to the transceiver 11, and/or to optical laser receivers 2.

An alternative preferred embodiment of the present invention is a method for detecting objects on an airport runway comprising detecting the presence of an object on the airport runway 3 by the object's interruption of one or more optical laser beams 4 generated by an optical system 10, processing the output from the optical system 10 to determine the location of the object on the runway 3, and transmitting the information regarding the object to appropriate personnel. The method may further comprise the step of processing the output from the optical system 10 to determine the type of object on the runway 3. The method may further comprise transmitting the information to a user interface to alert appropriate personnel. An alternative preferred embodiment of the above method comprises the steps of detecting the present of an object on an airport runway by the object's interruption of one or more optical laser beams generated by an optical system, processing the output from the optical system to determine the location of the object on the runway, processing the output from the optical system to determine the type of object on the runway, processing the output from the optical system to determine the appropriate degree of danger posed by the presence of the object on the runway, and transmitting the information regarding the object to a user interface.

The following embodiments and examples discussed herein are nonlimiting examples.

### EXAMPLE 1

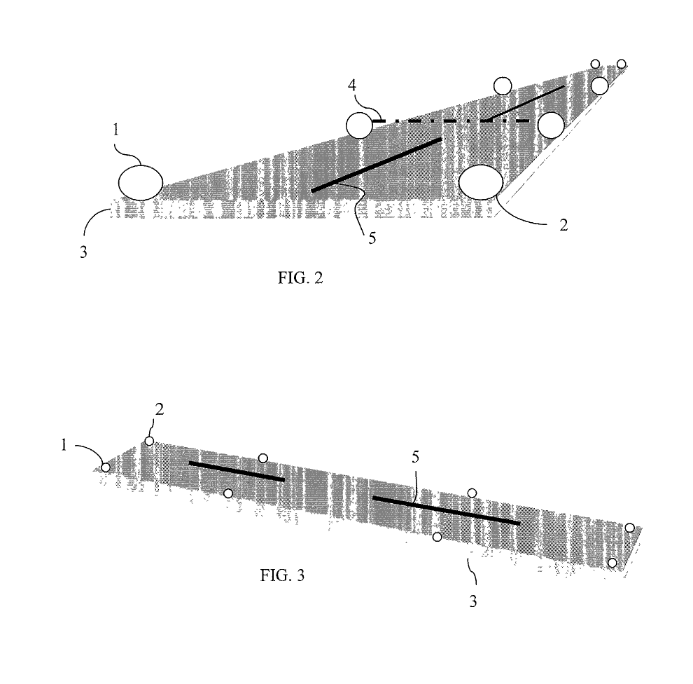

Reference is now made to FIG. 2 illustrating a 3-dimentional frontal view of the airport runway surface 3, with the center line 5 marking the width in an equal distance to both edges of the airport runway surface 3. The optical laser transmitter 1 which supplies the optical laser 4 to the optical laser receiver 2 is preferably located at the edge of the airport runway surface 3.

In the different configurations of embodiments that follow, transmitter 1 can also be used as a transceiver 11 with respect to receiver 2 and reflector 12. The location of the optical laser receiver 2 can be located on the opposite side facing back in the direction of the optical laser transmitter 1. Both the optical laser transmitter 1 and optical laser receiver 2 are positioned along the width down the length of the entire airport runway surface 3.

FIG. 3 illustrates the side view of a 3-dimentional airport runway surface 3 with the center line 5 marking the width in an equal distance to both edges, show optical laser embodiments, both optical laser transmitter 1 and optical laser receiver 2 are located around the parameter.

### EXAMPLE 2

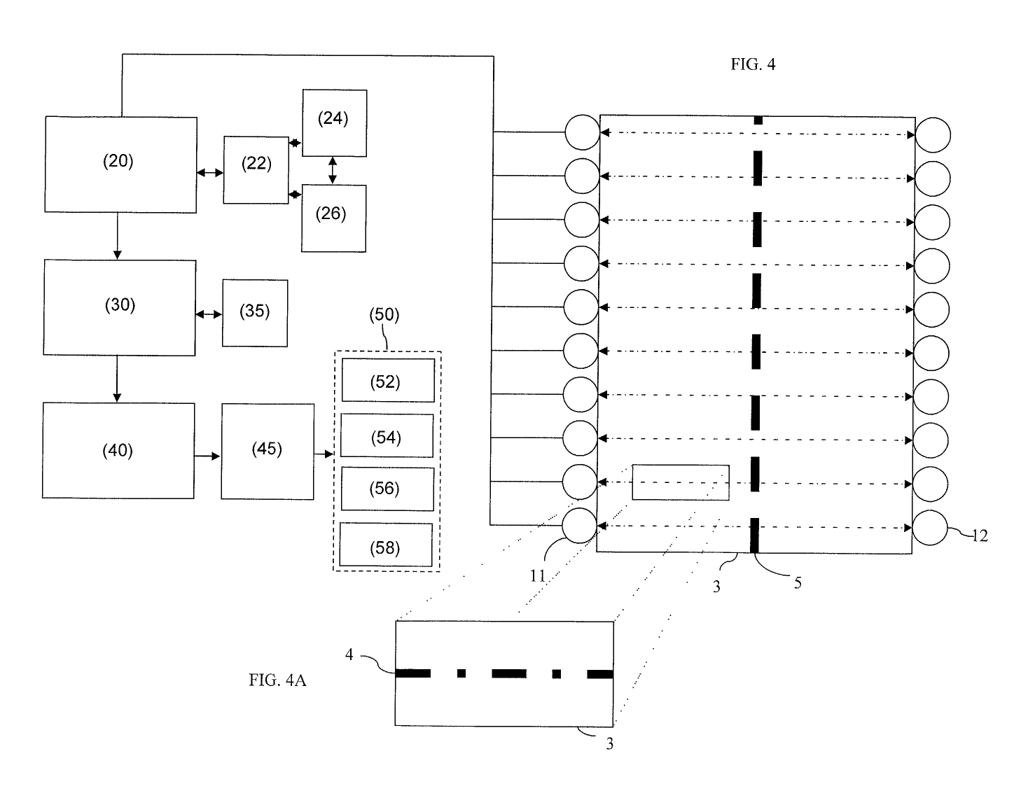

FIG. 4 illustrates a top view of the airport runway surface 3 with optical laser transceivers 11 and optical laser reflectors 12 on opposite sides of the airport runway surface 3. This configuration illustrates the arrangement of the optical laser 4 as magnified in FIG. 4A, which shows the configuration covering the width of the runway area specified. The optical laser 4 may be constantly traveling through several different planes while passing over the width of the airport runway surface 3.

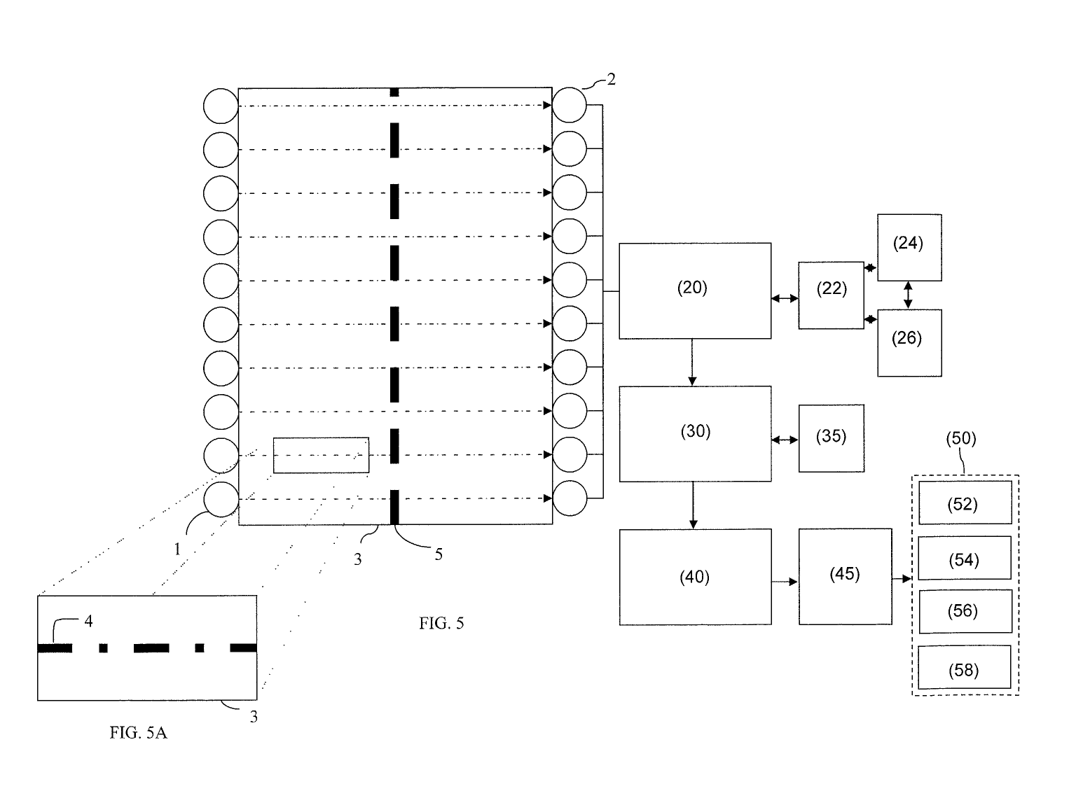

FIG. 5 illustrates a top view of the airport runway surface 3 showing the location of optical laser transmitters 1 on one side of the airport runway surface 3, and optical laser receivers 2 on the opposite side. The laser beam 4 as magnified in FIG. 5A illustrates the configuration covering the width of the area specified showing the direction from one side to the other and constantly traveling through several different planes.

### EXAMPLE 3

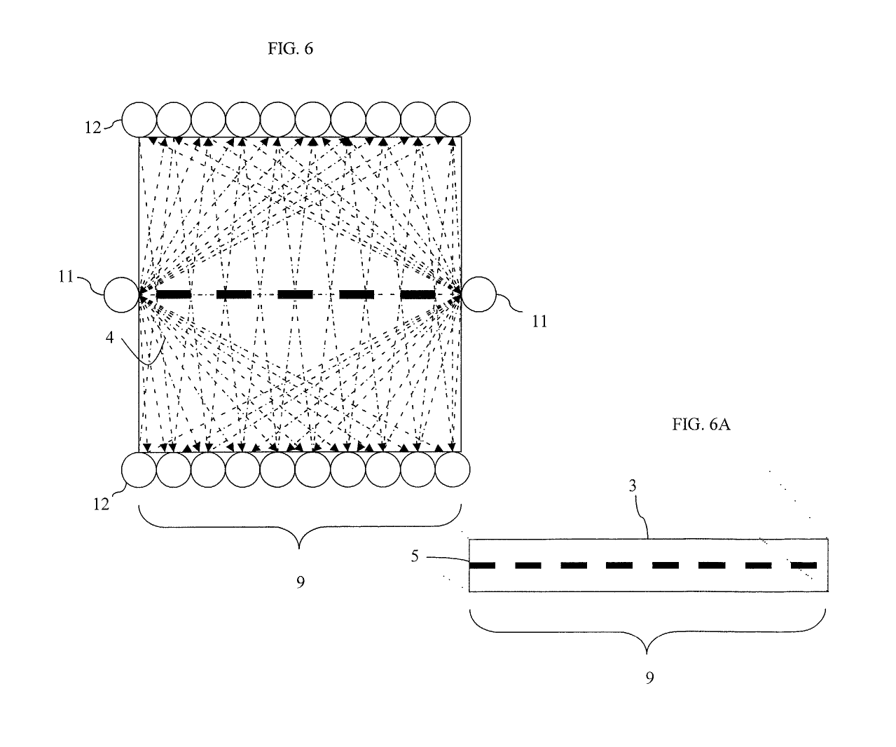

FIG. 6 is a top view of the airport runway surface 3 with optical laser transceivers 11 located on each end of the airport runway surface 3 on the center line 5 marking the width in an equal distance to both edges. Optical laser reflectors 12 are present on both sides of the runway surface 3 covering the length and width of area specified by reflecting optical lasers 4 from optical laser transceivers 11 in different directions, for example, three different directions, while constantly traveling through several different planes.

FIG. 6A is a simplified top view of the airport runway surface 3 illustrating where optical lasers 4 provide protection for aircraft within landing and take off sections 9 of the airport runway surface 3.

### EXAMPLE 4

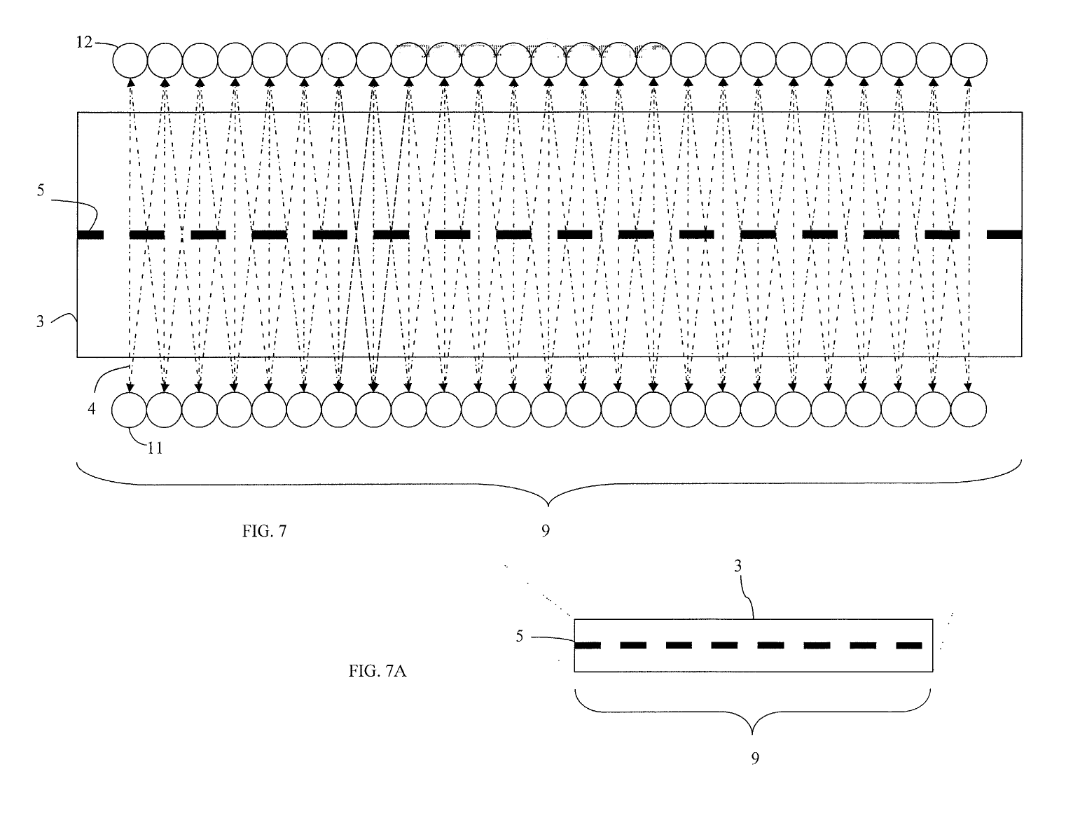

FIG. 7 illustrates a top view of the entire airport runway surface 3 with optical laser transceivers 11 located on one side of the airport runway surface 3, opposite of the optical laser reflectors 12. The area of coverage is shown with the optical laser beams 4 traveling across the width of the airport runway surface 3 in a configuration covering the width of area specified in both directions while constantly traveling through several different planes.

FIG. 7A is a simplified top view of the airport runway surface 3 illustrating where optical lasers 4 would provide protection for aircraft within landing and take off sections 9 of the airport runway surface 3.

### EXAMPLE 5

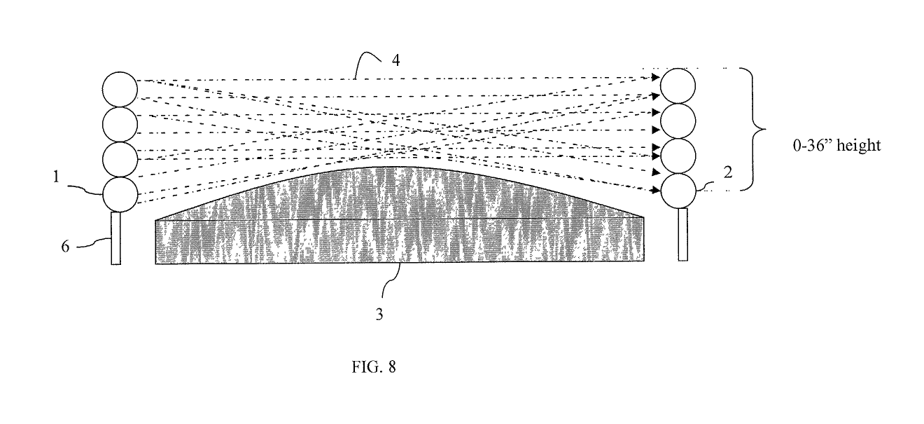

FIG. 8 is a front view of a convex airport runway surface 3 with optical laser transmitters 1 located on one side the supporting mechanism 6, opposite of the optical laser receivers 2 located on the other side of runway surface 3, also located on supporting mechanism 6. The direction of the optical lasers 4 show the configuration covering the width of the area specified in one direction from left to right while constantly traveling through several different planes, for example, but not limited to, within the range of 0.5 inches to 36 inches in height from the airport runway surface 3.

### EXAMPLE 6

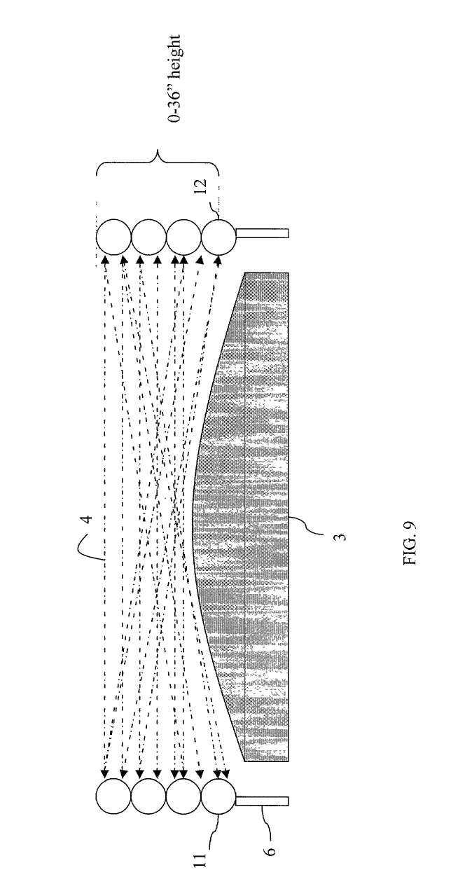

FIG. 9 is a front view of a convex airport runway surface 3 with optical laser transceivers 11 located on one side of the supporting mechanism 6, opposite of the optical laser reflectors 12 located on the other side of runway surface 3, also located on supporting mechanism 6. The direction of the optical lasers 4 show the configuration covering the width of the area specified in both directions from left to right while constantly traveling through several different planes, for example, but not limited to, within the range of 0.5 inches to 36 inches in height from the airport runway surface 3.

### EXAMPLE 7

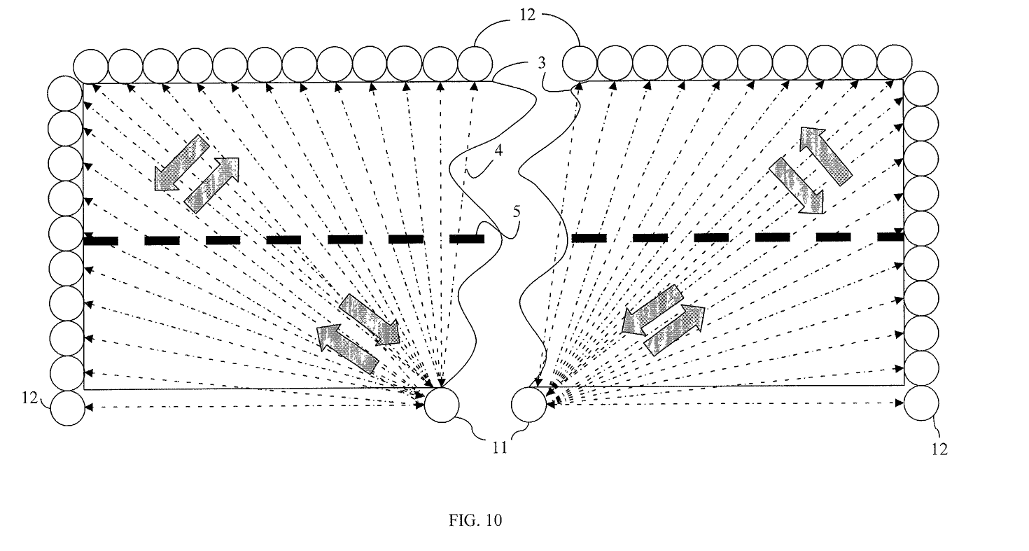

FIG. 10 is a top view of the entire airport runway surface 3, with optical laser transceivers 11 located on airport runway surface 3. Optical laser reflectors 12 are located across the airport runway surface 3 from the optical laser transceivers 11, as well as on both ends of the airport runway surface 3. The optical laser beam 4 configuration covers both the width and length of the airport runway surface 3. These optical laser beams 4 are in four different constant directions, two of which travel from the optical laser transceivers 11 to the optical laser reflectors 12 and return to the optical laser transceiver 11. Two of the other optical laser beams 4 are sweeping both left and right traveling through several different planes reflecting off of the optical laser reflectors 12 and returning to the optical laser transceivers 11. This configuration can either be set-up in sections down the entire airport runway surface 3 covering small sections, or can be configured in one big pattern to encompass the entire airport runway surface 3.

### EXAMPLE 8

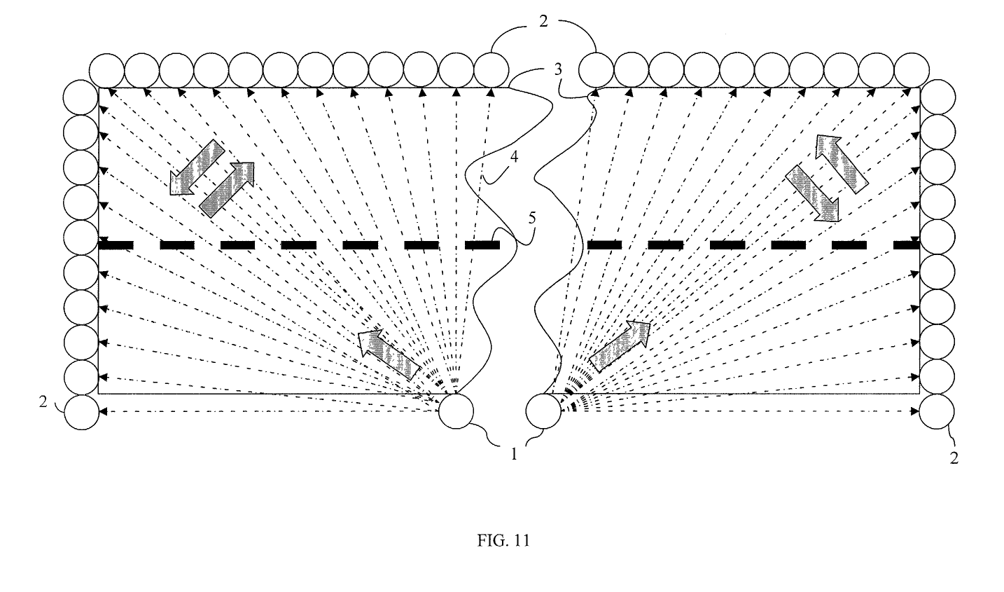

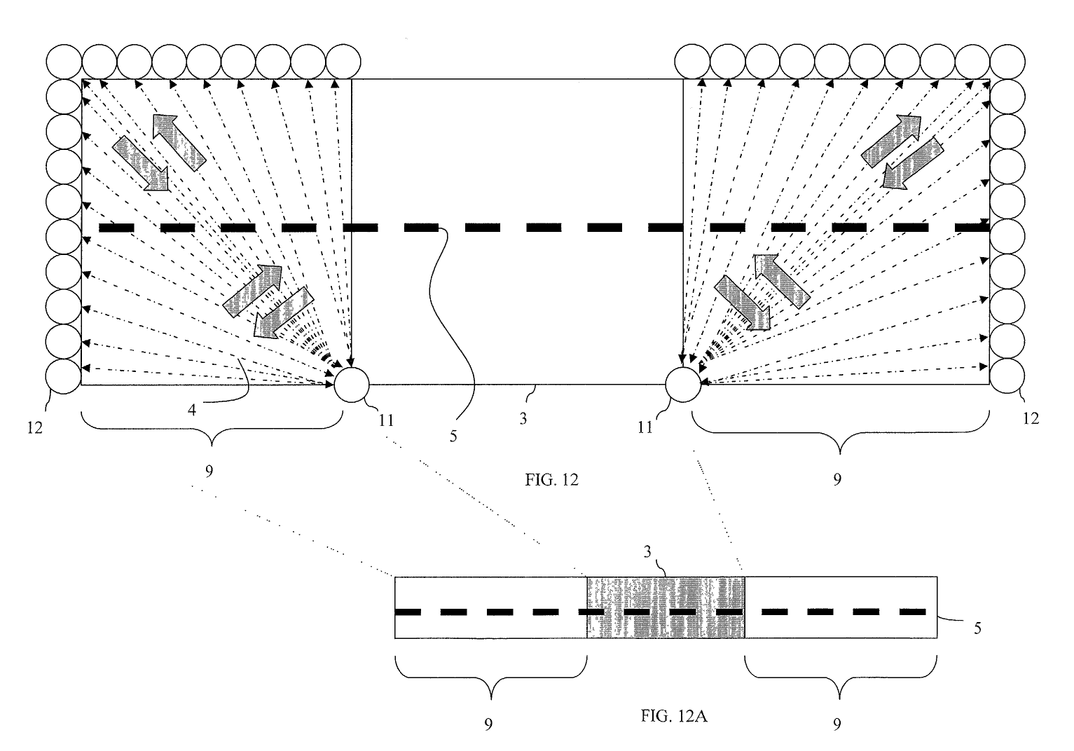

FIG. 11 is a top view of the entire airport runway surface 3, with optical laser transmitters 1 located on the airport runway surface 3. Optical laser receivers 2 are located across the airport runway surface 3 from the optical laser transmitters 1, as well as on both ends of the airport runway surface 3. The optical laser beam 4 configuration covers both the width and length of the airport runway surface 3. These optical laser beams 4 are in three different constant directions, one of which travels from the optical laser transmitter 1 to the optical laser receiver 2, and two of which are sweeping both left and right traveling through several different planes. This configuration can either be set-up in sections down the entire airport runway surface 3 covering small sections, or can be configured in one big pattern to encompass the entire airport runway surface 3.

### EXAMPLE 9

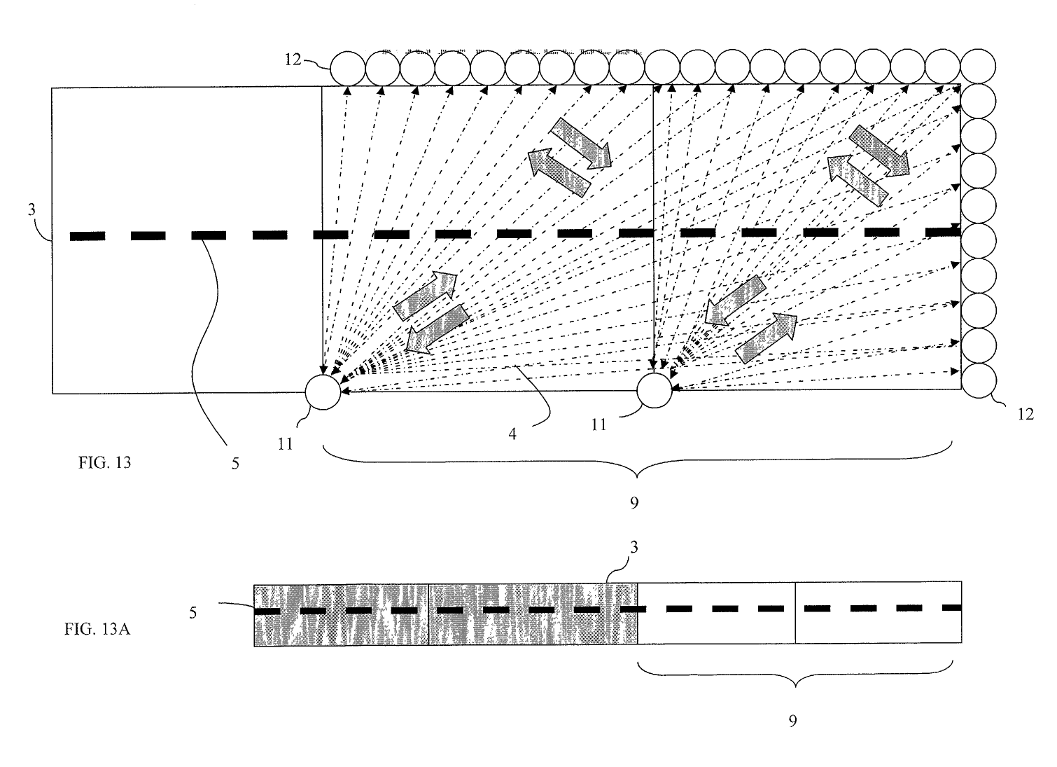

FIG. 12 is a top view of the entire airport runway surface 3, with optical laser transceivers 11 located at the end section of the airport runway surface 3. Optical laser reflectors 12 are located across the airport runway surface 3 from the optical laser transceivers 11, as well as on both ends of the airport runway surface 3. The optical laser beam 4 configuration covers both the width and length of the airport runway surface 3. These optical laser beams 4 are in four different constant directions, two of which travel from the optical laser transceivers 11 to the optical laser reflectors 12 and return to the optical laser transceivers 11. Two of the other optical laser beams 4 are sweeping both left and right traveling through several different planes. The configuration of this particular setup is located within the specific landing and take off sections 9 of the airport runway surface 3. FIG. 12A is a simplified top view of the airport runway surface 3 illustrating where optical laser beams 4 would provide protection for aircraft within landing and take off sections 9 of the airport runway surface 3.

### EXAMPLE 10

FIG. 13 is a top view of the entire airport runway surface 3, with optical laser transceivers 11 located at the end section of the airport runway surface 3. Optical laser reflectors 12 are located across the airport runway surface 3 from the optical laser transceivers 11, as well as on one end of the airport runway surface 3. The optical laser beam 4 configuration covers both the width and length of the airport runway surface 3. These optical laser beams 4 are in four different constant directions, two of which travel from the optical laser transceivers 11 to the optical laser reflectors 12 and return to the optical laser transceiver 11. Two of the other optical laser beams 4 are sweeping both left and right traveling through several different planes. The configuration of this particular setup is located within the specific landing and take off sections 9 of the airport runway surface 3. FIG. 13A is a simplified top view of the airport runway surface 3 illustrating where optical laser beams 4 would provide protection for aircraft within landing and take off sections 9 of the airport runway surface 3.

### EXAMPLE 11

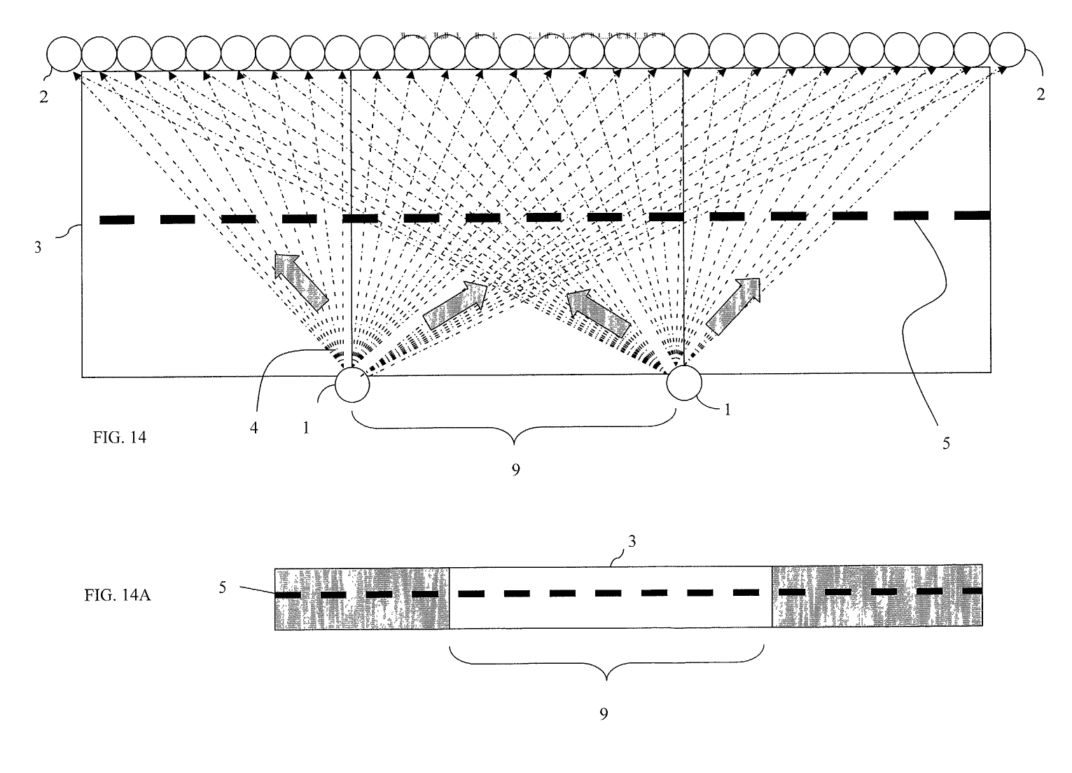

FIG. 14 is a top view of the entire airport runway surface 3, with optical laser transmitters 1 located on the airport runway surface 3. Optical laser receivers 2 are located along the entire length of the airport runway surface 3 across from the optical laser transmitters 1. The optical laser beam 4 configuration covers both the width and length of the airport runway surface 3. The optical laser beams 4 are in one constant direction which travels from the optical laser transmitter 1 to the optical laser receiver 2 traveling through several different planes. This configuration can either be set-up in sections down the entire airport runway surface 3 covering small sections, or can be configured in one large pattern to encompass the entire airport runway surface 3. FIG. 14A is a simplified top view of the airport runway surface 3 illustrating where optical laser beams 4 would provide protection for aircraft within landing and take off sections 9 of the airport runway surface 3.

### EXAMPLE 12

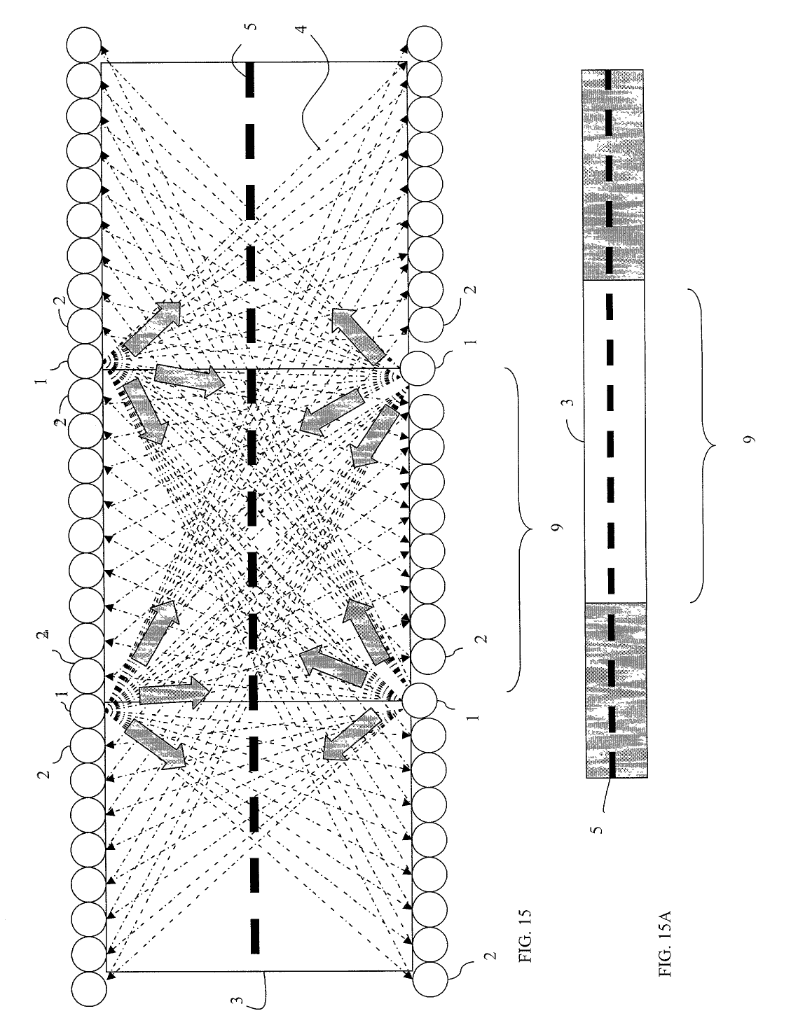

FIG. 15 is a top view of the entire airport runway surface 3, with a total of four optical laser transmitters 1, two located across from each other respectively on the airport runway surface 3. Optical laser receivers 2 are located along the entire length of the airport runway surface 3 next to the optical laser transmitters 1. The optical laser beam 4 configuration covers both the width and length of the airport runway surface 3. The optical laser beams 4 are in one constant direction which travels from the optical laser transmitter 1 to the optical laser receiver 2 traveling through several different planes. This configuration can either be set-up in sections down the entire airport runway surface 3 covering small sections, or can be configured in one large pattern to encompass the entire airport runway surface 3. FIG. 15A is a simplified top view of the airport runway surface 3 illustrating where optical laser beams 4 would provide protection for aircraft within landing and take off sections 9 of the airport runway surface 3.

### EXAMPLE 13

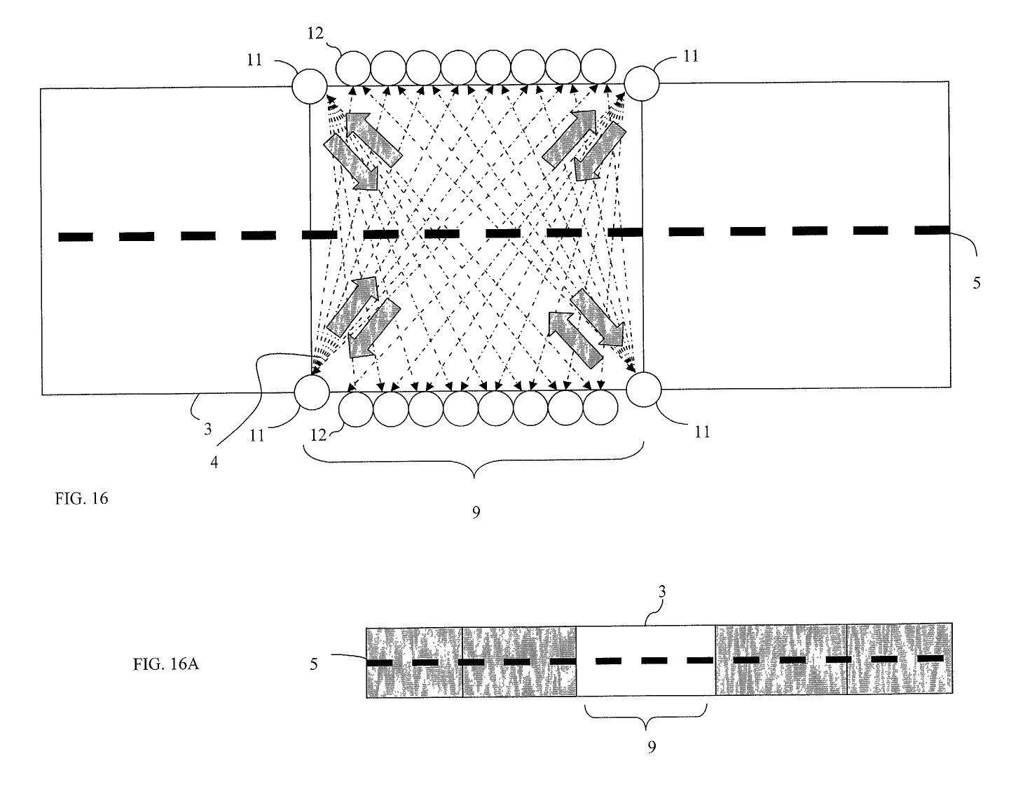

FIG. 16 is a top view of the entire airport runway surface 3, with four optical laser transceivers 11, each located at one corner of a square section of the airport runway surface 3. Optical laser reflectors 12 are located across the airport runway surface 3 from each other, able to reflect optical laser beams 4 over the width of the airport runway surface 3. The optical laser beam 4 configuration covers the width of the airport runway surface 3. These optical laser beams 4 are in two different constant directions of which travel from the optical laser transceivers 11 to the optical laser reflectors 12 and return to the optical laser transceivers 11 while traveling through several different planes. The configuration of this particular setup may be located within the specific landing and take off sections 9 of the airport runway surface 3. This configuration can either be set-up in sections down the entire airport runway surface 3 covering small sections, or can be configured in one large pattern to encompass the entire airport runway surface 3. FIG. 16A is a simplified top view of the airport runway surface 3 illustrating where optical laser beams 4 would provide protection for aircraft within landing and take off sections 9 of the airport runway surface 3.

### EXAMPLE 14

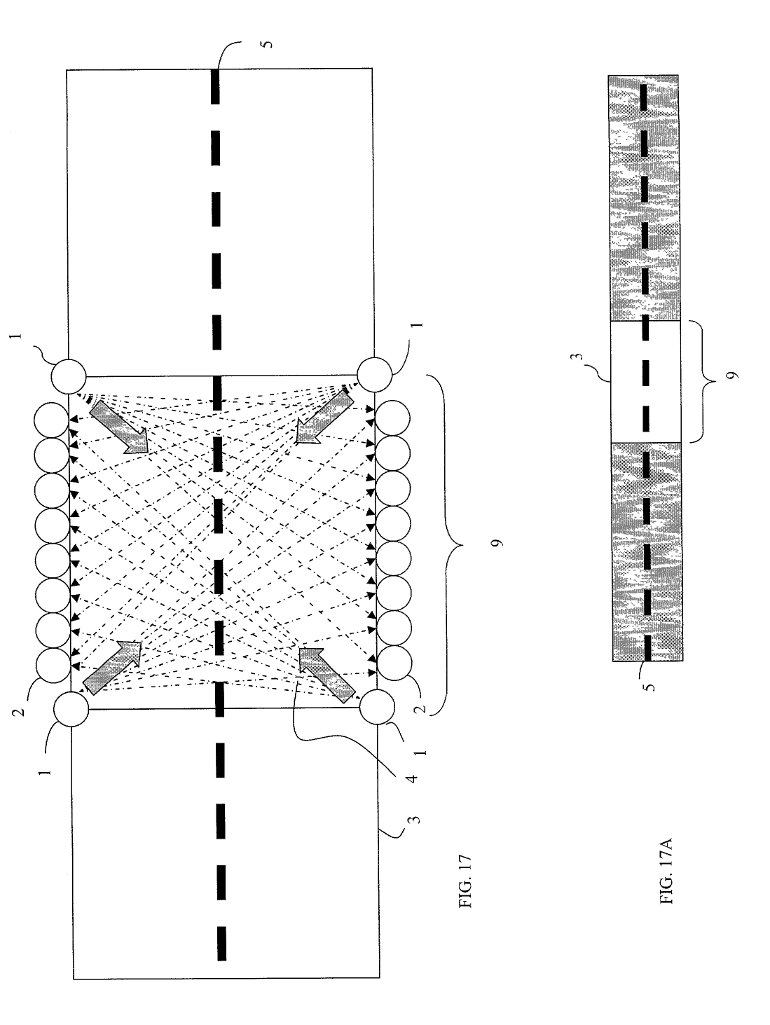

FIG. 17 is a top view of the entire airport runway surface 3, with four optical laser transmitters 1 each located at one corner of a square section of the airport runway surface 3. Optical laser receivers 2 are located across the airport runway surface 3 from each other, able to receive optical laser beams 4 over the width of the airport runway surface 3. The optical laser beam 4 configuration covers the width of the airport runway surface 3. These optical laser beams 4 are in one constant direction of which travels from the optical laser transmitters 1 to the optical laser receivers 2 while traveling through several different planes. The configuration of this particular setup may be located within the specific landing and take off sections 9 of the airport runway surface 3. This configuration can either be set-up in sections down the entire airport runway surface 3 covering small sections, or can be configured in one large pattern to encompass the entire airport runway surface 3. FIG. 17A is a simplified top view of the airport runway surface 3 illustrating where optical laser beams 4 would provide protection for aircraft within landing and take off sections 9 of the airport runway surface 3.

### EXAMPLE 15

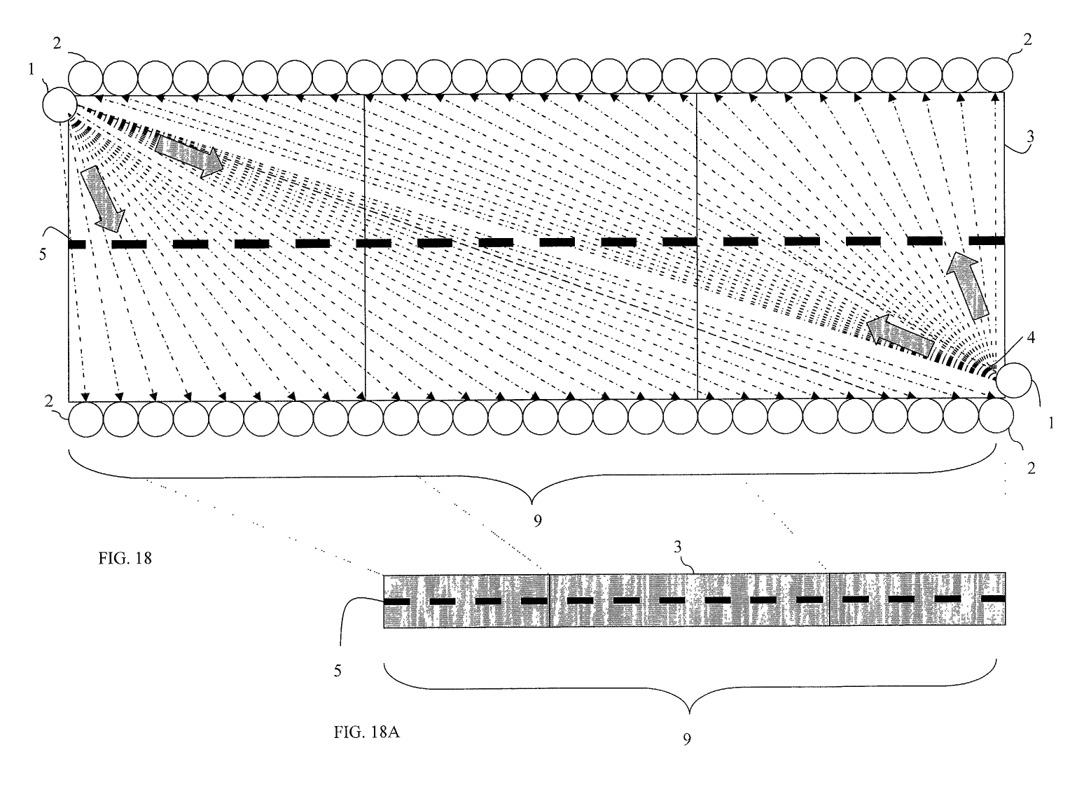

FIG. 18 is a top view of the entire airport runway surface 3, with a total of two optical laser transmitters 1, located diagonally across from each other respectively at the end of the airport runway surface 3 in opposite corners. Optical laser receivers 2 are located along the entire length of the airport runway surface 3 next to the optical laser transmitters 1. The optical laser beam 4 configuration covers both the width and length of the airport runway surface 3. The optical laser beams 4 are in one constant direction which travels from the optical laser transmitter 1 to the optical laser receiver 2 traveling through several different planes. This configuration can either be set-up in sections down the entire airport runway surface 3 covering small sections, or can be configured in one large pattern to encompass the entire airport runway surface 3. FIG. 18A is a simplified top view of the airport runway surface 3 illustrating where optical laser beams 4 would provide protection for aircraft within landing and take off sections 9 of the airport runway surface 3.

### EXAMPLE 16

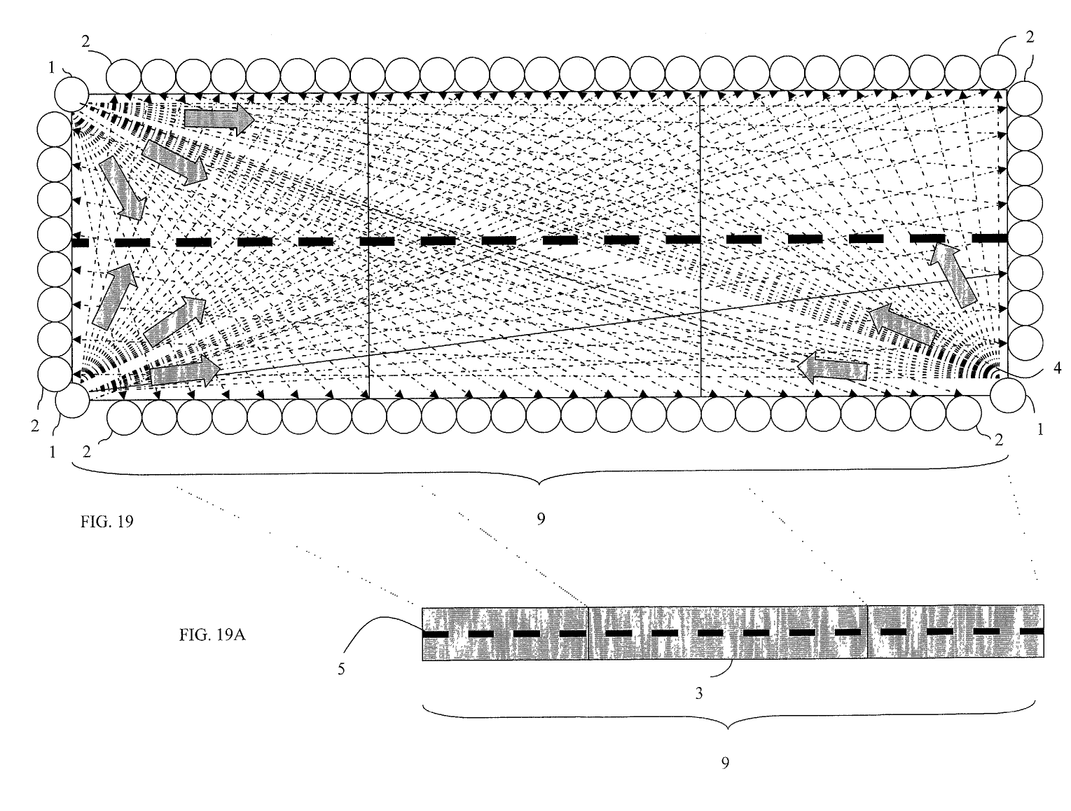

FIG. 19 is a top view of the entire airport runway surface 3, with a total of three optical laser transmitters 1, two of which are located diagonally across from each other respectively at the end of the airport runway surface 3 in opposite corners. The third optical laser transmitter 1 is located directly across from one of the optical laser transmitters 1 located at one end of the airport runway surface 3. Optical laser receivers 2 are located along the entire length of the airport runway surface 3, and at both ends of the airport runway surface 3. With this configuration the optical laser beam 4 covers both the width and length of the airport runway surface 3. The optical laser beams 4 are in one constant direction which travels from the optical laser transmitter 1 to the optical laser receiver 2 traveling through several different planes. This configuration can either be set-up in sections down the entire airport runway surface 3 covering small sections, or can be configured in one big pattern to encompass the entire airport runway surface 3. FIG. 19A is a simplified top view of the airport runway surface 3 illustrating where optical laser beams 4 would provide protection for aircraft within landing and take off sections 9 of the airport runway surface 3.

### EXAMPLE 17

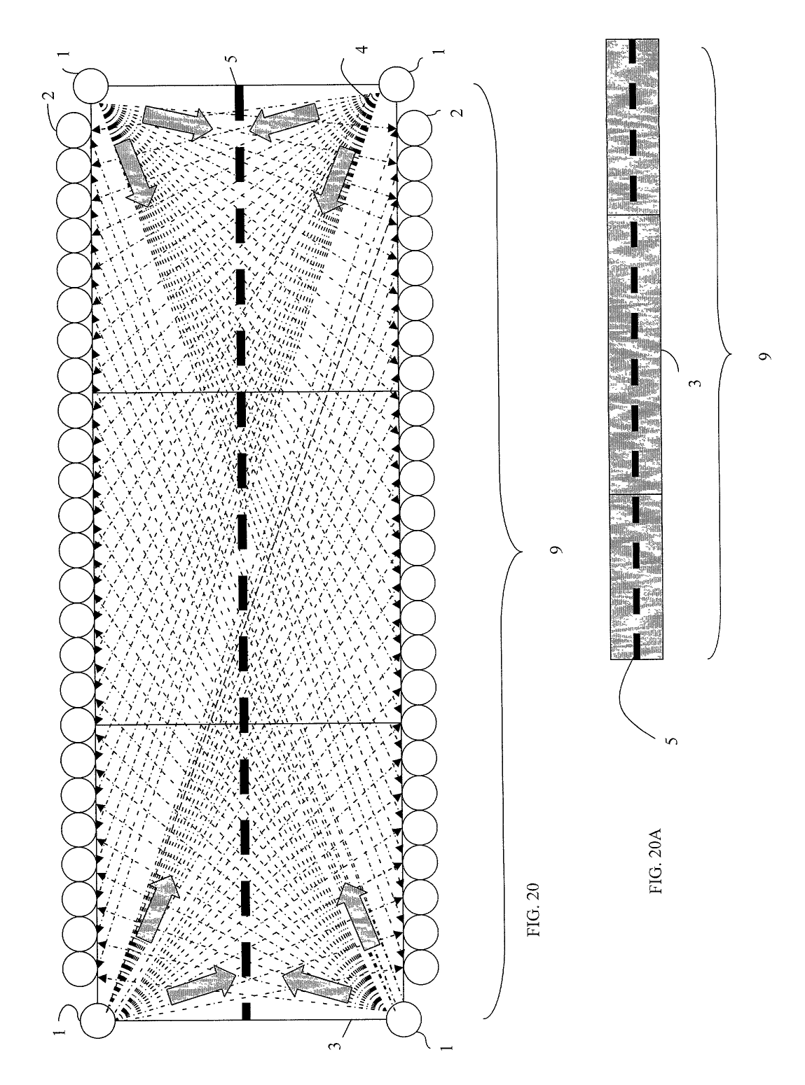

FIG. 20 is a top view of the entire airport runway surface 3, with a total of four optical laser transmitters 1, one of which is located at each corner of the airport runway surface 3. Optical laser receivers 2 are located along the entire length of the airport runway surface 3. With this configuration the optical laser beam 4 covers both the width and length of the airport runway surface 3. The optical laser beams 4 are in one constant direction which travel from the optical laser transmitters 1 to the optical laser receivers 2 traveling through several different planes. This configuration can either be set-up in sections down the entire airport runway surface 3 covering small sections, or can be configured in one large pattern to encompass the entire airport runway surface 3. FIG. 20A is a simplified top view of the airport runway surface 3 illustrating where optical laser beams 4 would provide protection for aircraft within landing and take off sections 9 of the airport runway surface 3.

### EXAMPLE 18

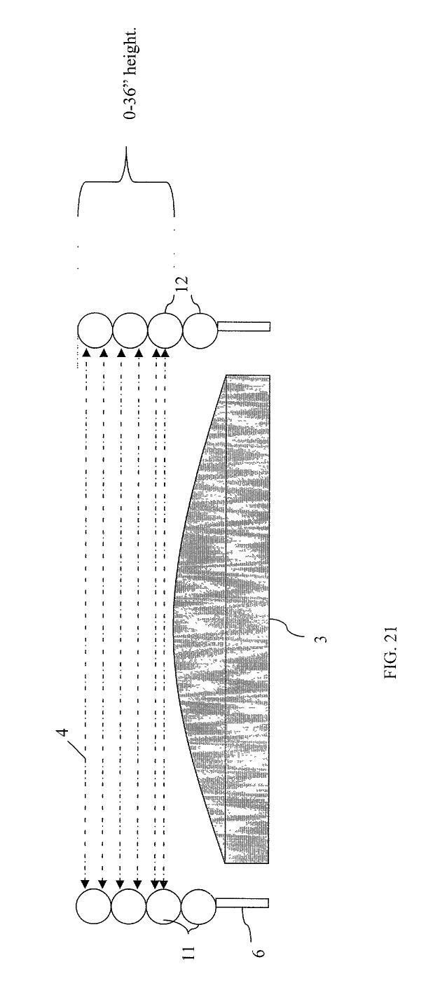

FIG. 21 is a front view of a convex airport runway surface 3 with optical transceivers 11 located on one side of the airport runway surface 3 across from optical laser reflectors 12 located on the other side of the airport runway surface 3. The optical laser beams 4 traveling from the optical laser transceivers 11 to the optical laser reflectors 12 and returning back to the optical laser transceivers 11 are configured to cover the width of the area specified in both directions constantly traveling through one plane, for example, but not limited to, within the range of 0.5 inches to 36 inches in height from the airport runway surface 3. This configuration can either be set-up in sections down the entire airport runway surface 3 covering small sections, or can be configured in one big pattern to encompass the entire airport runway surface 3.

### EXAMPLE 19

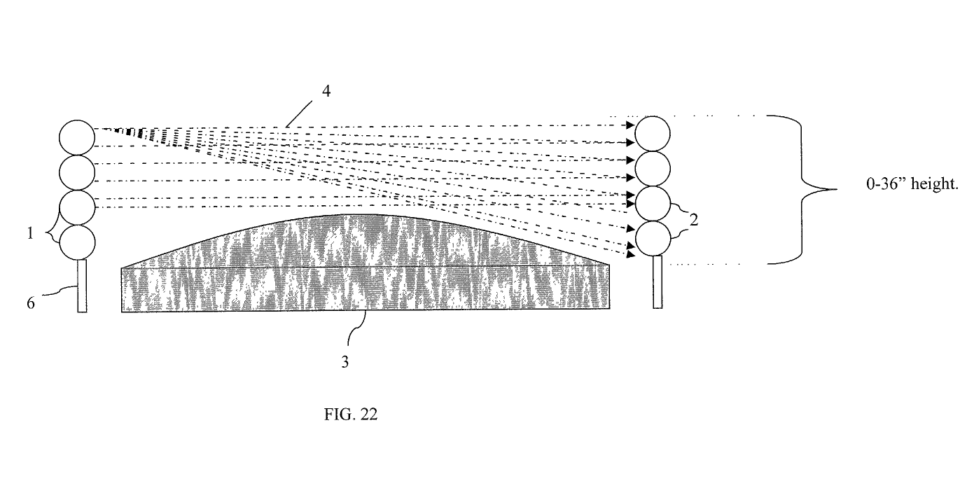

FIG. 22 is a front view of a convex airport runway surface 3 with optical transmitters 1 located on one side of the airport runway surface 3 across from optical laser receivers 2 located on the opposite side of the airport runway surface 3. The optical laser beams 4 traveling from the optical laser transmitters 1 to the optical laser receivers 2 are configured to cover the width of the area specified in one direction constantly traveling through several different planes, for example, but not limited to, within the range of 0.50 inches to 36 inches in height from the airport runway surface 3. This configuration can either be set-up in sections down the entire airport runway surface 3 covering small sections, or can be configured in one big pattern to encompass the entire airport runway surface 3.

### EXAMPLE 20

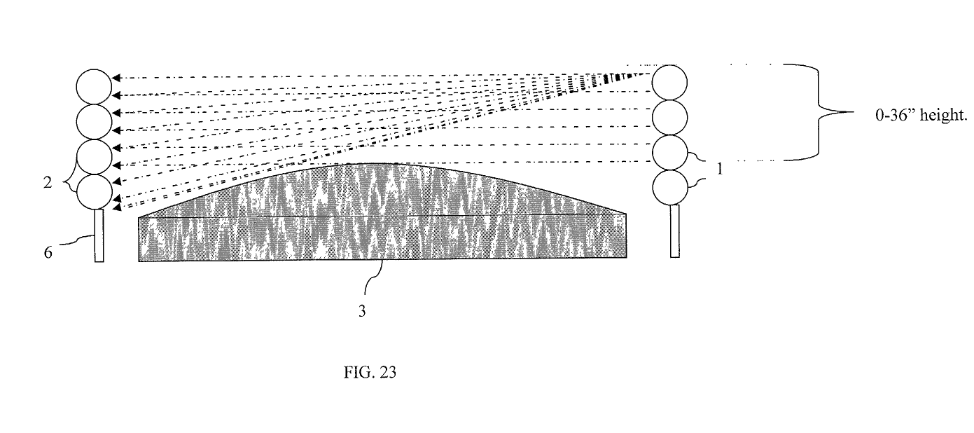

FIG. 23 is a front view of a convex airport runway surface 3 with optical transmitters 1 located on one side of the airport runway surface 3 across from optical laser receivers 2 located on the opposite side of the airport runway surface 3. The optical laser beams 4 traveling from the optical laser transmitters 1 to the optical laser receivers 2 are configured to cover the width of the area specified in one direction constantly traveling through several different planes, for example, but not limited to, within the range of 0.5 inches to 36 inches in height from the airport runway surface 3. This configuration can either be set-up in sections down the entire airport runway surface 3 covering small sections, or can be configured in one big pattern to encompass the entire airport runway surface 3.

### EXAMPLE 21

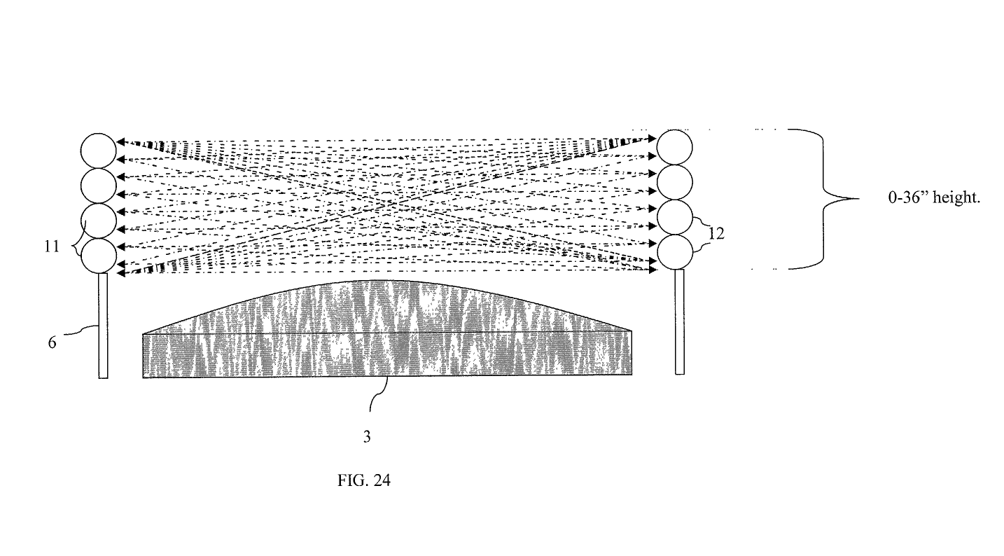

FIG. 24 is a front view of a convex airport runway surface 3 with optical transceivers 11 located on one side of the airport runway surface 3 across from optical laser reflectors 12 located on the opposite side of the airport runway surface 3. The optical laser beams 4 traveling from the optical laser transceivers 11 to the optical laser reflectors 12 are configured to cover the width of the area specified in both directions constantly traveling through several different planes, for example, but not limited to, within the range of 0.5 inches to 36 inches in height from the airport runway surface 3. This configuration can either be set-up in sections down the entire airport runway surface 3 covering small sections, or can be configured in one large pattern to encompass the entire airport runway surface 3.

### EXAMPLE 22

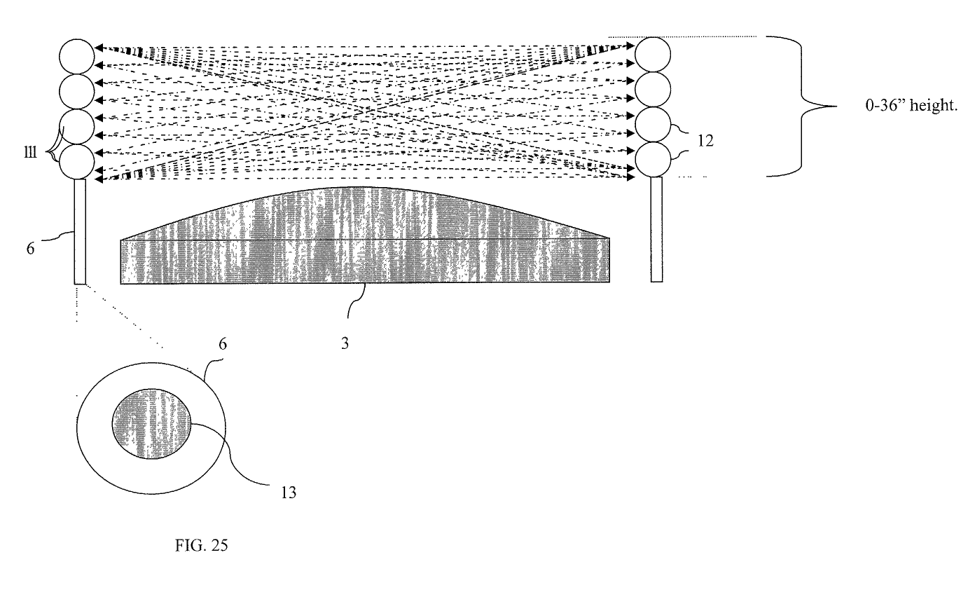

FIG. 25 is a front view of a convex airport runway surface 3, specifically showing a sectional view of the supporting mechanism 6 for holding the optical laser transmitter 1, optical laser receiver 2, optical laser transceiver 11, and the optical laser reflector 12. The inner core of the supporting mechanism 6 can have a heating element 13 located in or on the supporting mechanism 6 in order to maintain a constant temperature during inclement weather to prevent freezing of all optical laser system embodiments or the support mechanism.

### EXAMPLE 23

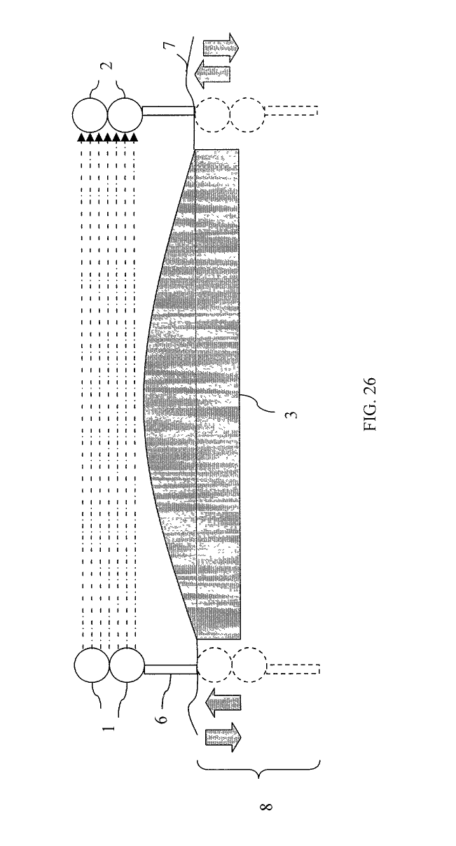

FIG. 26 is a front view of a convex airport runway surface 3, specifically showing the adjusting means 8 for the raising and lowering of supporting mechanism 6. The entire supporting mechanism 6 for holding the optical laser transmitter 1, optical laser receiver 2, optical laser transceiver 11, and the optical laser reflector 12 located at the width of the airport runway surface 3 would travel above and below ground 7. The above and below ground location of embodiments are in order to prevent the apparatus from becomein an obstacle during the removal of snow and ice from the airport runway surface 3.

### EXAMPLE 24

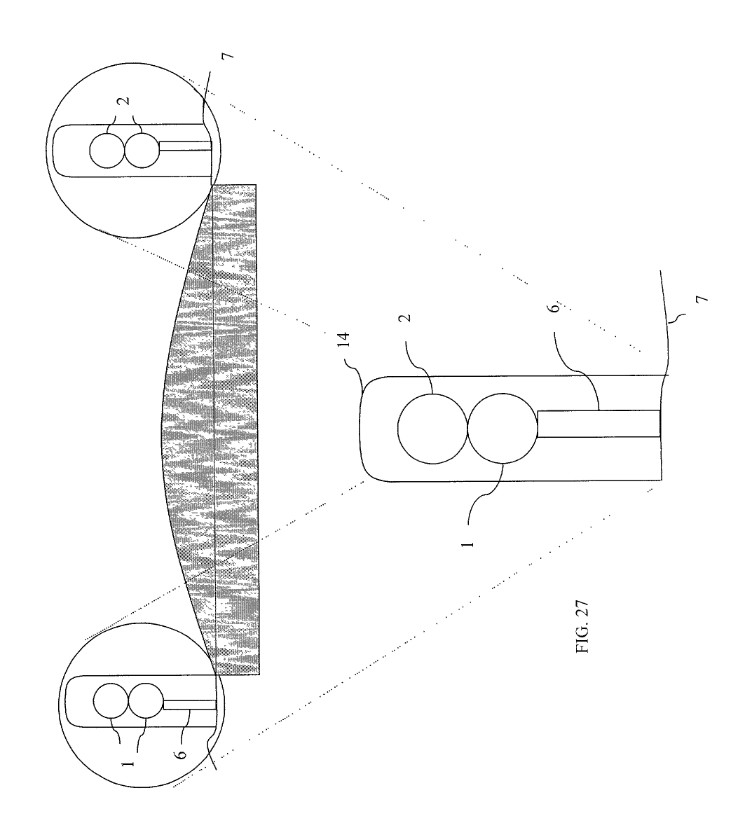

FIG. 27 is an illustration of a clear protective covering 14 that provides protection during inclement weather for the entire supporting mechanism 6, the optical laser transmitter 1, optical laser receiver 2, optical laser transceiver 11, and the optical laser reflector 12, located at the width of the airport runway surface 3.

### EXAMPLE 25

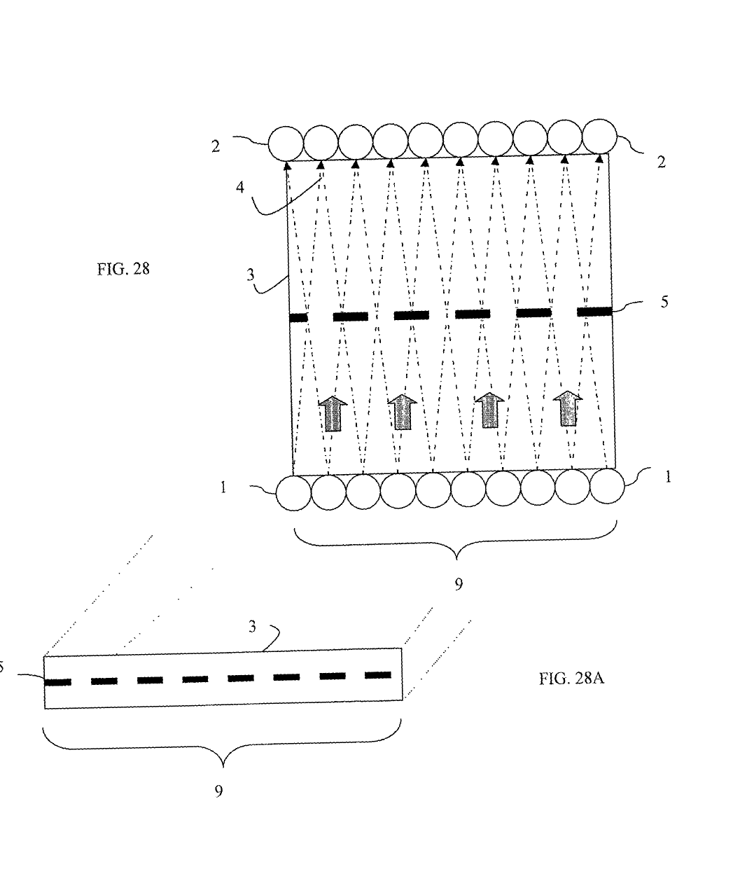

FIG. 28 is a top view of the entire airport runway surface 3, with an equal number of optical laser transmitters 1, located on the opposite side of the same number of optical laser receivers 2 located across the width of the airport runway surface 3. Optical laser receivers 2 are located along the entire length of the airport runway surface 3 opposite of the optical laser transmitters 1. The optical laser beam 4 configuration covers both the width and length of the airport runway surface 3. The optical laser beams 4 are in one constant direction which travels from the optical laser transmitter 1 to the optical laser receiver 2 traveling through several different planes. This configuration can either be set-up in sections down the entire airport runway surface 3 covering small sections, or can be configured in one large pattern to encompass the entire airport runway surface 3. FIG. 28A is a simplified top view of the airport runway surface 3 illustrating where optical laser beams 4 would provide protection for aircraft within landing and take off sections 9 of the airport runway surface 3.

### EXAMPLE 26

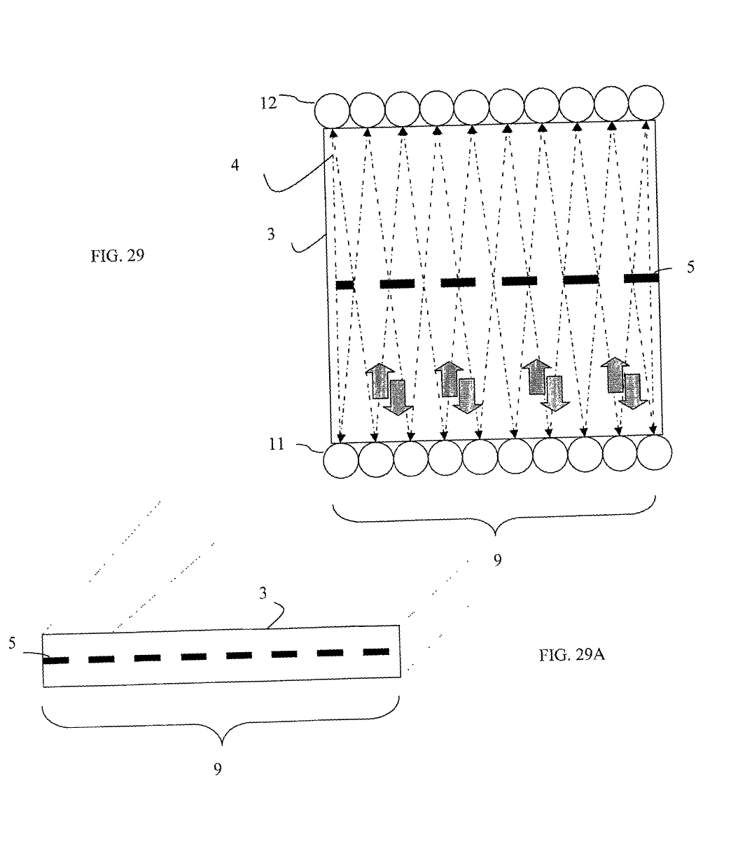

FIG. 29 is a top view of the entire airport runway surface 3, with an equal number of optical laser transceivers 11, and of optical laser reflectors 12 located across the width of the airport runway surface 3 from each other. Optical laser reflectors 12 are located along the entire length of the airport runway surface 3 opposite of the optical laser transceivers 11. The optical laser beam 4 configuration covers both the width and length of the airport runway surface 3. The optical laser beams 4 are in both constant directions which travel from the optical laser transceivers 11 to the optical laser reflectors 12 traveling through several different planes. This configuration can either be set-up in sections down the entire airport runway surface 3 covering small sections, or can be configured in one large pattern to encompass the entire airport runway surface 3. Optical laser transmitters 1 and receivers 2 may also be used in conjunction with optical laser reflectors 12 and/or optical laser transceivers 11. FIG. 29A is a simplified top view of the airport runway surface 3 illustrating where optical laser beam 4 would provide protection for aircraft within landing and take off sections 9 of the airport runway surface 3.

### EXAMPLE 27

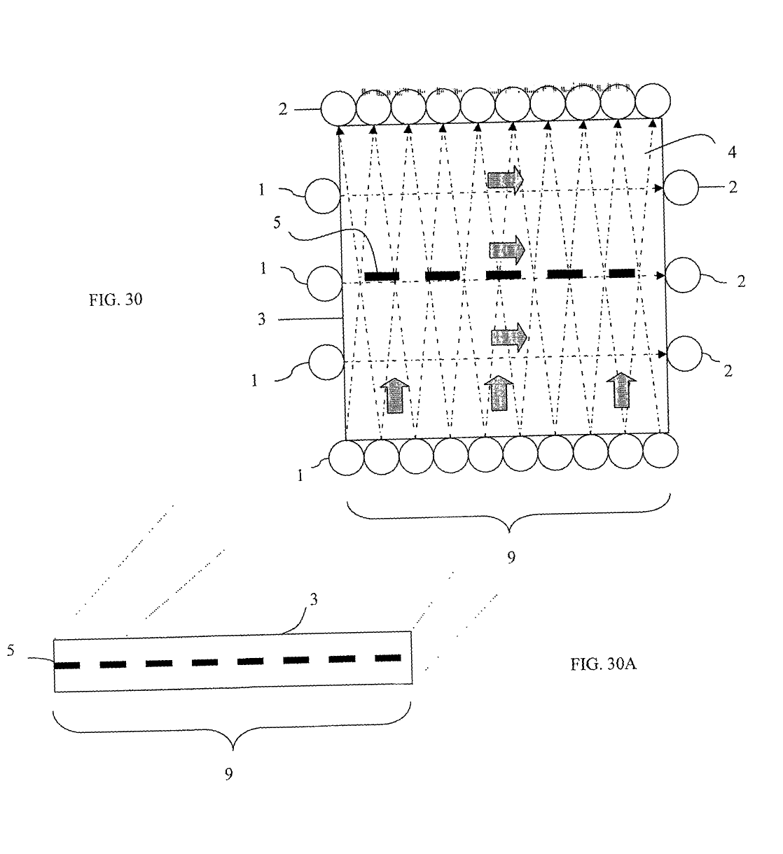

FIG. 30 is a top view of the entire airport runway surface 3, with an equal number of optical laser transmitters 1, and of optical laser receivers 2 located across from each other over the width and length of the of the airport runway surface 3. Optical laser receivers 2 are located along the entire length and width of the airport runway surface 3 opposite of the optical laser transmitters 1. The optical laser beam 4 configuration covers both the width and length of the airport runway surface 3. The optical laser beams 4 are in one constant direction which travel from the optical laser transmitters 1 to the optical laser receivers 2 traveling through several different planes over the width of the airport runway surface 3. The optical laser beams 4 may also travel in both constant directions which travel from the optical laser transmitters 1 to the optical laser receivers 2 traveling through several different planes over the length of the airport runway surface 3. This configuration can either be set-up in sections down the entire airport runway surface 3 covering small sections, or can be configured in one large pattern to encompass the entire airport runway surface 3. FIG. 30A is a simplified top view of the airport runway surface 3 illustrating where optical laser beams 4 would provide protection for aircraft within landing and take off sections 9 of the airport runway surface 3.

### EXAMPLE 28

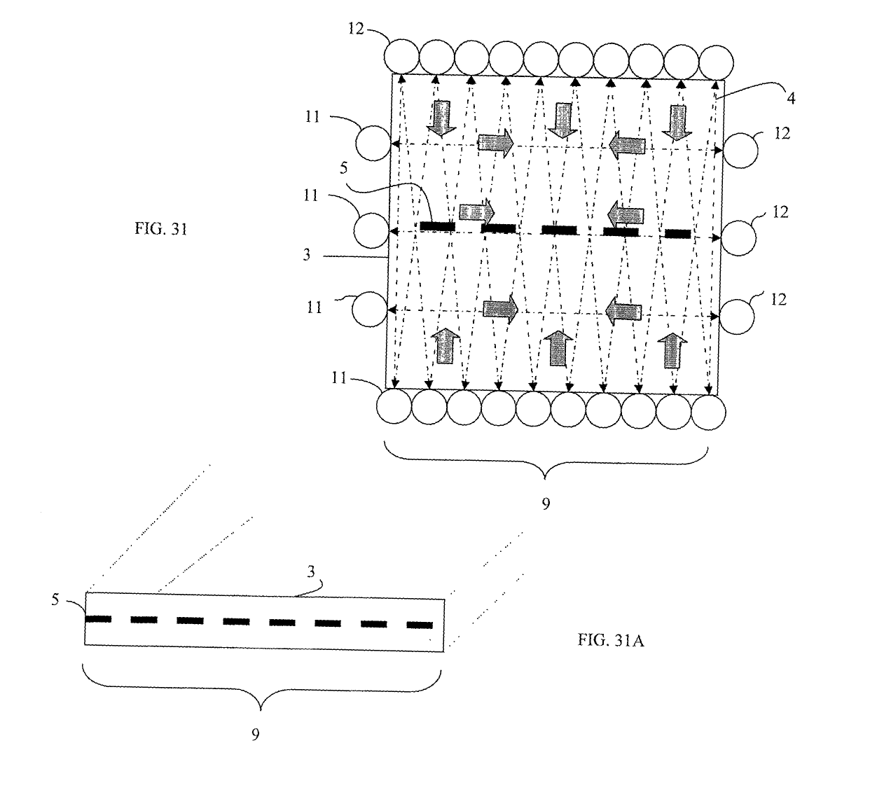

FIG. 31 is a top view of the entire airport runway surface 3, with an equal number of optical laser transceivers 11, and of optical laser reflectors 12 located across the width and length of the of the airport runway surface 3 from each other. Optical laser reflectors 12 are located along the entire length and width of the airport runway surface 3 opposite of the optical laser transceivers 11. The optical laser beam 4 configuration covers both the width and length of the airport runway surface 3. The optical laser beams 4 are in both constant directions which travel from the optical laser transceivers 11 to the optical laser reflectors 12 traveling through several different planes over the width of the airport runway surface 3. The optical laser beams 4 are in both constant directions which travel from the optical laser transceiver 11 to the optical laser reflectors 12 traveling through several different planes over the length of the airport runway surface 3. This configuration can either be set-up in sections down the entire airport runway surface 3 covering small sections, or can be configured in one large pattern to encompass the entire airport runway surface 3. FIG. 31A is a simplified top view of the airport runway surface 3 illustrating where optical laser beams 4 would a provide protection for aircraft within landing and take off sections 9 of the airport runway surface 3.

### EXAMPLE 29

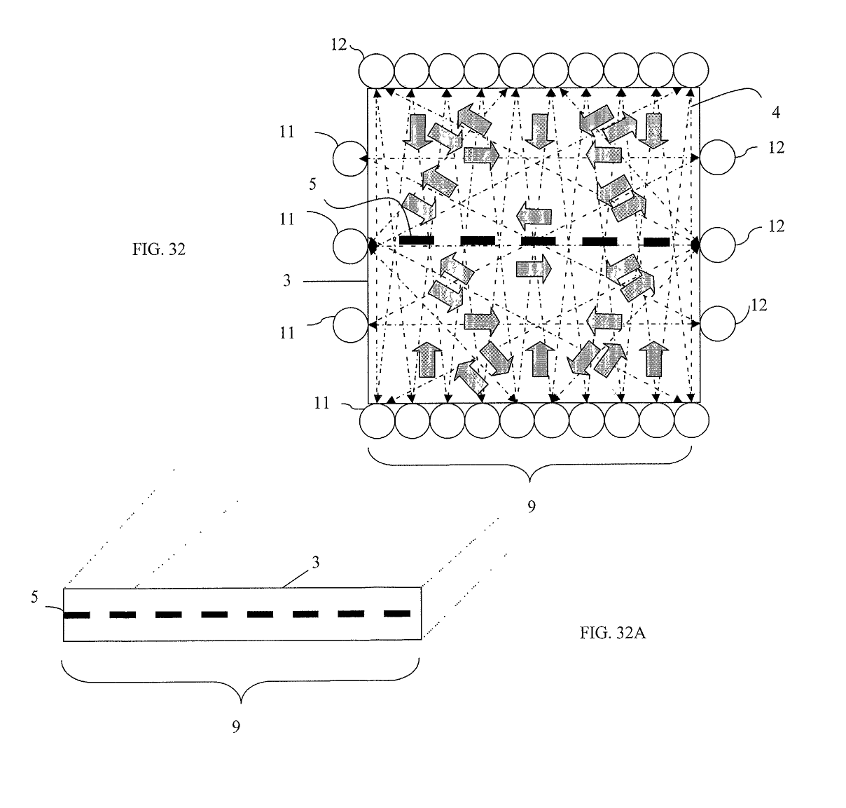

FIG. 32 is a top view of the entire airport runway surface 3, with an equal number of optical laser transceivers 11, and of optical laser reflectors 12, located across from each other along the width and length of the of the airport runway surface 3. Optical laser reflectors 12 are located along the entire length and width of the airport runway surface 3 opposite of the optical laser transceivers 11. The optical laser beam 4 configuration covers both the width and length of the airport runway surface 3. The optical laser beams 4 are in every possible constant direction which travels from the optical laser transceivers 11 to the optical laser reflectors 12 traveling through several different planes over the width of the airport runway surface 3. The optical laser beams 4 are in both constant directions which travel from the optical laser transceivers 11 to the optical laser reflectors 12 traveling through several different planes over the length of the airport runway surface 3. This configuration can either be set-up in sections down the entire airport runway surface 3 covering small sections, or can be configured in one large pattern to encompass the entire airport runway surface 3. FIG. 32A is a simplified top view of the airport runway surface 3 illustrating where optical laser beams 4 would provide protection for aircraft within landing and take off sections 9 of the airport runway surface 3.

The invention is described in detail with respect to preferred embodiments, and it will now be apparent from the foregoing to those skilled in the art that changes and modifications may be made without departing from the invention in its broader aspects, and the invention, therefore, as defined in the claims is intended to cover all such changes and modifications as fall within the true spirit of the invention.

I claim:

1. An apparatus for detecting objects on an airport runway comprising:
an optical system;
an object location processor operably linked to said optical system;
an object characterizer operably linked to said object location processor;
an alarm activation processor operably linked to said object characterizer;
an alarm generator operably linked to said alarm activation processor; and
a user interface operably linked to said alarm generator.

2. The apparatus according to claim 1, wherein said optical system further comprises one or more optical transmitters and one or more optical receivers.

3. The apparatus according to claim 1, wherein said optical system further comprises one or more optical transceivers and one or more optical reflectors.

4. The apparatus according to claim 2, further comprising one or more optical reflectors.

5. The apparatus according to claim 2, further comprising one or more optical transceivers.

6. The apparatus according to claim 1, wherein said object location processor further comprises an intrusion sensor detection system.

7. The apparatus according to claim 1, wherein said object location processor further comprises an operation sensor detection system.

8. The apparatus according to claim 1, wherein said object location processor further comprises an output inspector diagnostic system.

9. The apparatus according to claim 1, wherein said object characterizer further comprises a motion detection processor.

10. The apparatus according to claim 1 wherein said object characterizer processes the proximity of the object relative to the location of an aircraft.

11. The apparatus according to claim 1, wherein said user interface further comprises a graphical interface.

12. The apparatus according to claim 1, wherein said user interface further comprises a no alarm indicator.

13. The apparatus according to claim 1, wherein said user interface further comprises a future risk indicator.

14. The apparatus according to claim 1, wherein said user interface further comprises an imminent danger indicator.

15. The apparatus according to claim 1, further comprising a support mechanism for the optical system.

16. The apparatus according to claim 15 wherein said support mechanism further comprises means for adjusting the height of the support mechanism.

17. The apparatus according to claim 15 wherein said support mechanism further comprises means for adjusting the height of the optical system.

18. The apparatus according to claim 15 wherein said support mechanism further comprises means for heating the support mechanism and the optical system.

19. The apparatus according to claim 1 wherein said optical system further comprises a protective cover.

20. An apparatus for detecting objects on an airport runway comprising:
an optical system;
wherein said optical system further comprises one or more optical transmitters and one ore more optical receivers; one or more optical transceivers and one or more optical reflectors; or a combination of optical transmitters/optical receivers and optical transceivers/optical reflectors;
an object location processor operably linked to said optical system;
an object characterizer operably linked to said object location processor;
an alarm activation processor operably linked to said object characterizer;
an alarm generator operably linked to said alarm activation processor; and
a user interface operably linked to said alarm generator.

21. The apparatus according to claim 20, wherein said object location processor further comprises one or more selected from the group consisting of an intrusion sensor detection system, an operation sensor detection system, and an output inspector diagnostic system.

22. The apparatus according to claim 20, wherein said object characterizer further comprises a motion detection processor.

23. The apparatus according to claim 20, wherein said user interface further comprises one or more selected from the group consisting of a graphical interface, a no alarm indicator, a future risk indicator, and an imminent danger indicator.

24. The apparatus according to claim 20, further comprising a support mechanism for said optical system.

25. The apparatus according to claim 24 wherein said support mechanism further comprises means for adjusting the height of one or more selected from the group consisting of said support mechanism and said optical system.

26. The apparatus according to claim 24 wherein said support mechanism further comprises means for heating the support mechanism and the optical system.

27. The apparatus according to claim 24 wherein said optical system further comprises a protective cover.

28. An apparatus for detecting objects on an airport runway comprising:
an optical system;
wherein said optical system further comprises
one or more optical transmitters and one ore more optical receivers; or
one or more optical transceivers and one or more optical reflectors;
or a combination of optical transmitters/optical receivers and optical transceivers/optical reflectors;
an object location processor operably linked to said optical system;
wherein said object location processor further comprises one or more selected from the group consisting of an intrusion sensor detection system, an operation sensor detection system, and an output inspector diagnostic system;
an object characterizer operably linked to said object location processor;
wherein said object characterizer further comprises a motion detection processor;
an alarm activation processor operably linked to said object characterizer;
an alarm generator operably linked to said alarm activation processor; and
a user interface operably linked to said alarm generator.

29. The apparatus according to claim 28, wherein said user interface further comprises one or more selected from the group consisting of a graphical interface, a no alarm indicator, a future risk indicator, and an imminent danger indicator.

30. The apparatus according to claim 28, further comprising a support mechanism for said optical system.

31. The apparatus according to claim 28 wherein said support mechanism further comprises means for adjusting the height of one or more selected from the group consisting of said support mechanism and said optical system.

32. The apparatus according to claim 31 wherein said support mechanism further comprises means for heating the support mechanism and the optical system.

33. The apparatus according to claim 31 wherein said optical system further comprises a protective cover.

34. An apparatus for detecting objects located on an airport runway surface comprising:
a) one or more optical laser transmitters and one or more optical laser receivers;
b) one or more optical laser transceivers and one or more optical laser reflectors; or
c) any combination of a) and b);
for sensing the presence of objects on an airport runway surface.

35. An apparatus for detecting objects or other debris on an airport runway surface comprising one or more optical laser transmitters arranged to transmit optical laser beams across portions of a runway surface; one or more of optical laser receivers arranged to receive said optical lasers, and an object location processor to process signals from said one or more of optical laser receivers to determine the presence of an object on the runway surface.

36. The apparatus of claim 35, further comprising reflectors arranged to reflect said optical lasers to optical laser transceivers or receivers.

37. The apparatus according to claim 35 further comprising one or more optical laser transceivers and one or more optical laser reflectors for sensing the presence of objects on an airport runway surface.

38. A method for detecting objects on an airport runway comprising:
a) detecting the presence of an object on an airport runway by the object's interruption of one or more optical laser beams generated by an optical system;
b) processing the output from the optical system to determine the location of the object on the runway;
c) transmitting the information regarding the object to appropriate personnel.

39. The method according to claim 38 further comprising the step of processing the output from the optical system to determine the type of object on the runway.

40. The method according to claim 38 wherein said step of transmitting the information regarding the object to appropriate personnel further comprises transmitting the information to a user interface to alert appropriate personnel.

41. A method for detecting objects on an airport runway comprising:
a) detecting the presence of an object on an airport runway by the object's interruption of one or more optical laser beams generated by an optical system;
b) processing the output from the optical system to determine the location of the object on the runway;
c) processing the output from the optical system to determine the type of object on the runway;
d) processing the output from the optical system to determine the appropriate degree of danger posed by the presence of the object on the runway;
e) transmitting the information regarding the object to a user interface.
